(19) United States
(12) Patent Application Publication
(10) Pub. No.: US 2022/0415319 A1
(43) Pub. Date: Dec. 29, 2022

(54) ON-DEVICE GENERATION AND PERSONALIZATION OF ZERO-PREFIX SUGGESTION(S) AND USE THEREOF

(71) Applicant: GOOGLE LLC, Mountain View, CA (US)

(72) Inventors: Jeff J. Nainaparampil, Ft. Lauderdale, FL (US); Chih-Wei Chen, San Jose, CA (US); Umesh R. Patil, Cupertino, CA (US)

(21) Appl. No.: 17/360,250

(22) Filed: Jun. 28, 2021

(51) Int. Cl. G10L 15/22; G06N 20/00

(52) U.S. Cl. CPC G10L 15/22; G06N 20/00; G10L 2015/223; G10L 2015/227

(57) ABSTRACT

Implementations described herein relate to generating, locally at a client device, corresponding subset(s) of zero-prefix suggestions, for a user of the client device, and for suggestion state(s) associated with the client device, and subsequently causing the client device to utilize the corresponding subset(s) of zero-prefix suggestions. The suggestion state(s) and a superset of candidate zero-prefix suggestions can be processed, using machine learning model(s), to generate a corresponding score for each of the candidate zero-prefix suggestions and with respect to the suggestion state(s). Further, zero-prefix suggestions can be selected for inclusion in the corresponding subset(s) of zero-prefix suggestions, and for the suggestion state(s), based on the corresponding scores. Accordingly, when a given suggestion state is subsequently detected at the client device, a given corresponding subset of zero-prefix suggestions that is stored in association with the given suggestion state can be obtained and provided for presentation to the user.

### BACKGROUND

Humans may engage in human-to-computer dialogs with interactive software applications referred to herein as “automated assistants” (also referred to as “chatbots,” “interactive personal assistants,” “intelligent personal assistants,” “personal voice assistants,” “conversational agents,” etc.). For example, humans (which when they interact with automated assistants may be referred to as “users”) may provide spoken natural language input (i.e., spoken utterances) to an automated assistant, which may in some cases be converted into text and then processed, and/or by providing textual (e.g., typed) natural language input or touch input. An automated assistant generally responds to these user inputs by providing responsive user interface output (e.g., audible and/or visual user interface output), controlling smart networked device(s), and/or performing other action(s).

In some cases, an automated assistant may proactively provide zero-prefix suggestions to users that are predicted to be helpful for a given user. For example, if a user accesses an automated assistant application that is associated with an automated assistant and that is accessible at a client device, the automated assistant can cause various zero-prefix suggestions to be provided for presentation to the user. These zero-prefix suggestions are primarily sourced from recent user interactions between the user and the automated assistant, trending user interactions between other users and respective automated assistants, or are previously curated suggestions for a population of users. However, these zero-prefix suggestions are generally not tailored to the given user of the client device for different contexts that are specific to the given user due to privacy considerations of server-based computing and certain contexts only being available for on-device computing. Moreover, these zero-prefix suggestions are generally provided for presentation to the user immediately upon the automated assistant application being launched and while other components of the client device that are utilized in providing the zero-prefix suggestions are being activated, thereby compounding the issue of tailoring these zero-prefix suggestions to the given user.

### SUMMARY

Implementations disclosed herein are directed to generating, locally at a client device, corresponding subsets of zero-prefix (ZP) suggestions, for a given user of the client device, and for corresponding suggestion states associated with the client device, and subsequently causing the client device to utilize the corresponding subsets of ZP suggestions in providing one or more ZP suggestions for presentation to the user. A given corresponding subset of ZP suggestions for the given user and for a given suggestion state, of a plurality of disparate corresponding suggestion states, can be generated by identifying the given suggestion state, identifying a superset of candidate ZP suggestions, processing, using ranking machine learning (ML) model(s), the given suggestion state and the superset of candidate ZP suggestions to generate a corresponding score for each of the candidate ZP suggestions and with respect to the given suggestion state, and selecting, based on the corresponding scores, one or more of the candidate ZP suggestions, from the superset of candidate ZP suggestions, for inclusion in the given corresponding subset of ZP suggestions for the given user and for a given suggestion state. The given suggestion state and the given corresponding subset of ZP suggestions for the given suggestion state can be stored in on-device memory (or storage) of the client device. Accordingly, when an occurrence of the given suggestion state is subsequently detected at the client device, one or more ZP suggestions can be obtained from the given corresponding subset of ZP suggestions stored in association with the given suggestion state, and can be provided for presentation to the user via the client device or an additional computing device in communication with the client device. When a user selection of a given ZP suggestion is received, the client device, or an automated assistant executing at least in part at the client device, can cause a corresponding action that is associated with the given ZP suggestion to be performed.

In some implementations, each of the plurality of disparate corresponding suggestion states can represent a different contextual scenario with varying degrees of granularity, and, as a result, a corresponding subset of ZP suggestions for each of the plurality of disparate corresponding suggestion states can include one or more ZP suggestions that are relevant to each of the different contextual scenarios. Put another way, the given corresponding subset of ZP suggestions can include ZP suggestions that are tailored to the user and that are relevant to a contextual scenario represented by the given suggestion state. Further, each of the plurality of disparate corresponding suggestion states can be represented by different combinations of one or more device signals generated by the client device or an additional computing device in communication with the client device. The one or more device signals can include, for example, a location of the client device, a semantic indication of the location of the client device, a time or range of times associated with the location of the client device, a date associated with the location of the client device, a calendar entry associated with a calendar software application of the client device, an electronic communication associated with one or more electronic communication software applications of the client device, a given software application running in a foreground of the client device, a given software application running in a background of the client device, historical usage of one or more software applications accessible at the client device, an indication of one or more additional client devices in communication with the client device, a clipboard that includes content copied at the client device, changes in devices states of additional computing devices in communication with the client device, and/or other device signals.

For example, assume a time associated with a location of the client device indicates the time is 6:00 PM. In this example, a given suggestion state associated with the client device may be an “evening” suggestion state. Further assume that the location of the client device indicates that the user is at a restaurant. In this example, a given suggestion state associated with the client device may be a more specific “restaurant in the evening” suggestion state. Further assume that a semantic identifier associated with the restaurant indicates that it is a Thai restaurant. In this example, a given suggestion state associated with the client device may be an even more specific “Thai restaurant in the evening” suggestion state. Further assume that a calendar entry of the user indicates that the user is at the Thai restaurant to celebrate a birthday of the user's child. In this example, a given suggestion state associated with the client device may be a yet even more specific “Thai restaurant in the evening for child's birthday” suggestion state. Accordingly, based on the different combinations of device signals, the suggestion states can be defined with varying degrees of granularity, and corresponding subsets of ZP suggestions can be generated for each of these suggestion states. The client device can identify (or anticipate) these different combinations of signals to identify each of the plurality of disparate suggestion states.

In some implementations, the superset of candidate ZP suggestions can be identified based on a plurality of user interactions. In some versions of these implementations, the superset of candidate ZP suggestions can be based on user interactions of the user of the client device when these different combinations of signals are detected at the client device. Continuing with the above example where the user is visiting the Thai restaurant in the evening for a child's birthday, assume that when the user typically visits restaurants (the specific Thai restaurant or other restaurants), the user typically interacts with a health and fitness application accessible at the client device to track calories consumed during dinner, and interacts with a browser application accessible at the client device to look at reviews of various dishes served at the restaurant. In this example, each of these user interactions can be included in the superset of candidate ZP suggestions. In additional or alternative versions of these implementations, the superset of candidate ZP suggestions can be based on user interactions of other users via respective client devices when these different combinations of signals are detected at the client device. Continuing with the above example where the user is visiting the Thai restaurant in the evening for a child's birthday, assume that when the other users typically visit restaurants, the other users interact with a calculator application accessible at the respective client devices to determine an appropriate amount of money to tip a server, and the other users interact with a translation application accessible at the respective client devices to obtain a translation of one or more dish names. In this example, each of these user interactions can additionally or alternatively be included in the superset of candidate ZP suggestions. Notably, the superset of candidate ZP suggestions can include a plurality of user interactions that are encountered in various other contextual scenarios that may not be specific to the given suggestion state. For example, the superset of candidate ZP suggestions can further include candidate ZP suggestions that are determined based on user interactions detected when the client device (or respective client devices) is connected to an additional computing device (e.g., an in-vehicle computing device, Bluetooth headphones, etc.), when the user wakes up, when the user is commuting to work, when the user is commuting home from work, before the user goes to bed, and/or any other contextual scenarios. Accordingly, the superset of candidate ZP suggestions can include candidate ZP suggestions that are determined based on a variety of different contextual scenarios.

In some implementations, the ranking ML model(s) can include a personal ranking ML model that is personalized to the given user of the client device, whereas in other implementations, the ranking ML model(s) can include a global ML model that is not personalized to the given user of the client device. In these implementations, the corresponding scores can be generated for each of the candidate ZP suggestions, included in the superset of candidate ZP suggestions, and with respect to each of the plurality of corresponding disparate suggestion states. For example, assume that 20 disparate suggestion states associated with the client device are identified based on different combinations of device signals as described above. Further assume that the superset of candidate ZP suggestions includes 100 different candidate ZP suggestions. In this example, the 20 disparate suggestion states and the 100 different candidate ZP suggestions can be processed using the ranking ML model(s) to generate the corresponding scores for each of the 100 different candidate ZP suggestions and with respect to the 20 disparate suggestion states associated with the client device. In other words, the corresponding scores can include 2,000 corresponding scores, or a corresponding score for each different candidate ZP suggestion and for each of the 20 disparate suggestion states. In some implementations, a threshold quantity of candidate ZP suggestions can be selected based on the corresponding scores for inclusion in each of the corresponding subsets of ZP suggestions. Continuing with the above example, assume the threshold quantity of candidate ZP suggestions to be selected for inclusion in each of the corresponding subsets of ZP suggestions is 10. In this example, 10 candidate ZP suggestions can be selected for each of the 20 disparate suggestion states based on the corresponding scores. Each of the corresponding subsets of ZP suggestions can be stored in on-device memory (or storage) of the client device in association with a corresponding suggestion state for which the corresponding subset of ZP suggestions was generated.

In some implementations, one or more of the ZP suggestions that are selected for inclusion in the corresponding subsets may need to be tailored to the given user of the client device. In these implementations, one or more of the ZP suggestions that include a corresponding placeholder can be identified, and user profile data stored in the on-device memory (or storage) of the client device can be utilized to determine a corresponding personalized identifier to be utilized in populating the corresponding placeholders. Continuing with the above example where the user is visiting the Thai restaurant in the evening for a child's birthday, assume the user typically interacts with a particular health and fitness application accessible at the client device to track calories consumed during dinner. However, assume the user has multiple health and fitness applications that are accessible at the client device. In this example, a ZP suggestion selected for inclusion in the corresponding subset of ZP suggestions may include “Track calories using [X] application”, where “X” is a corresponding placeholder for a particular application that the user utilizes when tracking calories. Further, the user profile data can be utilized to identify the particular health and fitness application accessible at the client device that the user utilizes when tracking calories. Although the above example is provided with respect to the corresponding personalized identifier being a preferred software application, it should be understood that is for the sake of example and is not meant to be limiting. For example, the corresponding personalized identifier can include one or more particular contact entries of a contacts application that is accessible at the client device, one or more smart networked device identifiers of smart networked device application(s), and/or any other personalized identifiers that can be determined based on the user profile data.

In some implementations, the corresponding subsets of ZP suggestions may only be generated when one or more device conditions of the device are satisfied. The one or more device conditions of the client device of the given user can include, for example, that the client device is charging, that the client device has at least a threshold state of charge, that a temperature of the client device is less than a threshold, that the client device is not being held by the given user, that a new suggestion state associated with the client device has been detected, a time of day at a location of the client device, a day of week at the location of the client device, and/or any other device conditions described herein. Put another way, the corresponding subsets of ZP suggestions may only be generated during off-peak times of usage of the client device by the given user to avoid interfering with performance of the client device. Moreover, in some implementations, the corresponding subsets of ZP suggestions may be subsequently updated when one or more device conditions of the device are subsequently satisfied and after a threshold duration of time has lapsed. The corresponding subsets of ZP suggestions may be subsequently updated in the same or similar manner described above, but with respect to updated suggestion states and/or an updated superset of candidate ZP suggestions.

In some implementations, a user selection of a given ZP suggestion (or lack thereof) can be utilized to update a corresponding subset of ZP suggestions for a given suggestion state. For example, the selection of the given ZP suggestion (or lack thereof) can be utilized to influence which ZP suggestions, from among the corresponding subset of ZP suggestions, should be provided for presentation to the given user in response to detecting a future occurrence of the given suggestion state. Put another way, the selection of the given ZP suggestion (or lack thereof) can be utilized to modify the corresponding score associated with the given ZP suggestion and optionally modify the corresponding scores associated with the other ZP suggestions that are provided for presentation to the given user. For instance, and assuming the given ZP suggestion is selected by the given user, the system can modify the corresponding score associated with the given ZP suggestion to make it more likely the given ZP suggestion will be provided for presentation to the given user in response to detecting a future occurrence of the given suggestion state. Also, for instance, and assuming none of the ZP suggestions are selected by the given user, the system can modify the corresponding scores associated with those ZP suggestions to make it less likely those ZP suggestions will be provided for presentation to the given user in response to detecting a future occurrence of the given suggestion state.

By using techniques described herein, one or more technical advantages can be achieved. As one non-limiting example, the techniques described herein can be utilized to generate, locally at a client device, corresponding subsets of ZP suggestions for corresponding suggestion states, thereby ensuring privacy of user data is secure at the client device since no user data is transmitted to a remote system (e.g., server(s)), and improving a ZP suggestion interface by providing ZP suggestions that are specifically tailored to the given user of the client device. Further, the techniques described herein can be utilized to generate the corresponding subsets of ZP suggestions during off-peak hours of usage of the client device by the given user. As a result, a given corresponding subset of ZP suggestions can be quickly and efficiently be obtained while other components of the client device are being activated, thereby reducing latency in providing ZP suggestions for presentation to the given user. For instance, other components that are typically utilized in generating and providing ZP suggestions may take time to be activated and process data utilized in generating ZP suggestions, and subsequently providing the ZP suggestions for presentation to the given user. However, by previously indexing the corresponding subsets of ZP suggestions in the manner described herein, the need for these other components to be activated for providing ZP suggestions is obviated.

The above description is provided as an overview of only some implementations disclosed herein. Those implementations, and other implementations, are described in additional detail herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts an example process flows that demonstrate various aspects of the present disclosure, in accordance with various implementations.

FIG. 3 depicts a flowchart illustrating an example method of generating, locally at a client device, corresponding subset(s) of zero-prefix suggestions, for a user of the client device, and for suggestion state(s) associated with the client device, and subsequently causing the client device to utilize the corresponding subset(s) of zero-prefix suggestions, in accordance with various implementations.

FIG. 4 depicts a flowchart illustrating an example method of utilizing corresponding subset(s) of zero-prefix suggestions that were previously generated locally at a client device based on detecting occurrence(s) of suggestion state(s), in accordance with various implementations.

FIG. 5A, FIG. 5B, FIG. 5C, and FIG. 5D depict various non-limiting examples of utilizing corresponding subset(s) of zero-prefix suggestions that were previously generated locally at a client device based on detecting occurrence(s) of suggestion state(s), in accordance with various implementations.

FIG. 6 depicts an example architecture of a computing device, in accordance with various implementations.

### DETAILED DESCRIPTION

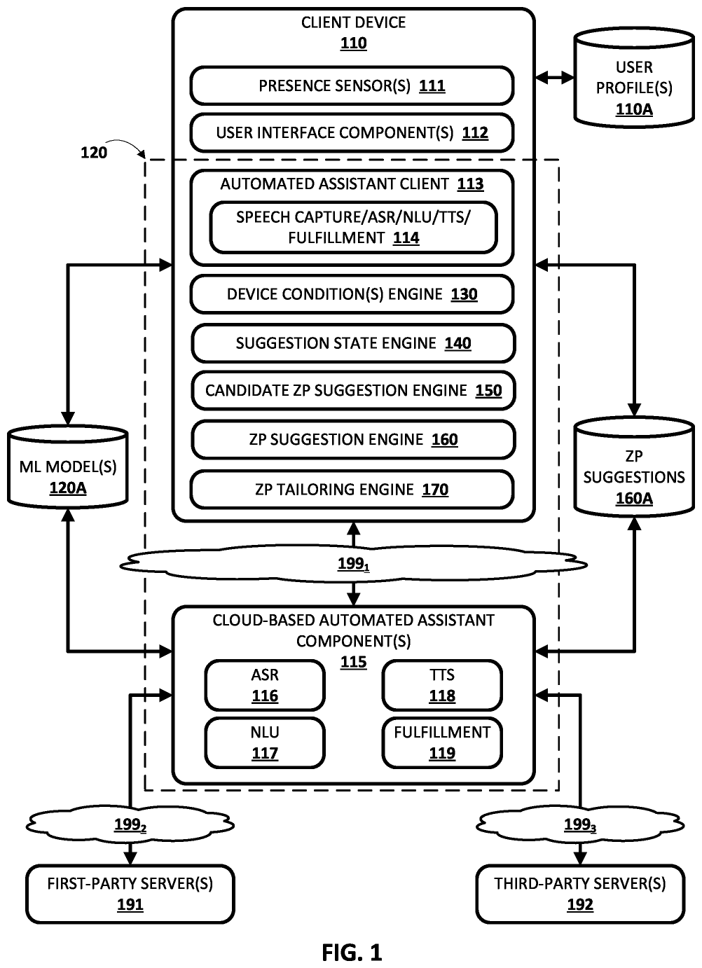

Turning now to FIG. 1, a block diagram of an example environment that demonstrates various aspects of the present disclosure, and in which implementations disclosed herein can be implemented is depicted. The example environment includes a client device 110, one or more cloud-based automated assistant components 115, one or more first-party servers 191, and one or more third-party servers 192.

The client device 110 can execute an automated assistant client 113. The automated assistant client 113 can be an application that is separate from an operating system of the client device 110 (e.g., installed “on top” of the operating system)—or can alternatively be implemented directly by the operating system of the client device 110. As described further below, the automated assistant client 113 can optionally interact with one or more of the cloud-based automated assistant components 115 in responding to various requests received by user interface component(s) 112 of the client device 110. Further, and as also described below, other engine(s) of the client device 110 can optionally interact with one or more of the cloud-based automated assistant components 115.

The one or more cloud-based automated assistant components 115 can be implemented on one or more computing systems (e.g., server(s) collectively referred to as a “cloud” or a “remote” computing system) that are communicatively coupled to the client device 110 via one or more local area networks (“LANs,” including Wi-Fi LANs, Bluetooth networks, near-field communication networks, mesh networks, etc.), wide area networks (“WANs,”, including the Internet, etc.), and/or other networks. The communicative coupling of the cloud-based automated assistant components 115 with the client device 110 is indicated generally by 199₁ of FIG. 1. Also, in some implementations, the client device 110 may be communicatively coupled with other client devices (not depicted) that are described herein via one or more networks (e.g., LANs and/or WANs).

The one or more of cloud-based automated assistant components 115 can also be communicatively coupled with one or more of the first-party servers 191 and/or one or more of the third-party servers 192 via one or more networks (e.g., LANs, WANs, and/or other networks). The communicative coupling of the cloud-based automated assistant components 115 with the one or more of the first-party servers 191 is indicated generally by 199₂ of FIG. 1. Further, the communicative coupling of the cloud-based automated assistant components 115 with the one or more of the third-party servers 192 is indicated generally by 199₃ of FIG. 1. In some implementations, and although not explicitly depicted in FIG. 1, the client device 110 can additionally or alternatively be communicatively coupled with one or more of the first-party servers 191 and/or one or more of the third-party servers 192 via one or more networks (e.g., LANs, WANs, and/or other networks).

The automated assistant client 113, by way of its interactions with one or more of the cloud-based automated assistant components 115, may form what appears to be, from a user's perspective, a logical instance of an automated assistant 120 with which the user of the client device 110 may engage in a human-to-computer dialog. For example, an instance of the automated assistant 120 encompassed by a dashed line includes the automated assistant client 113 of the client device 110 and one or more cloud-based automated assistant components 115. It thus should be understood that each user that engages with the automated assistant client 113 executing on the client device 110 may, in effect, engage with his or her own logical instance of the automated assistant 120 (or a logical instance of the automated assistant 120 that is shared amongst a household or other group of users and/or shared amongst multiple automated assistant clients 113). Although only the client device 110 is illustrated in FIG. 1, it is understood that one or more of cloud-based automated assistant components 115 can additionally serve many additional groups of client devices. Moreover, although the cloud-based automated assistant components 115 are illustrated in FIG. 1, it is understood that, in various implementations, the automated assistant 120 can be implemented exclusively at the client device 110.

As used herein, a first-party device or system (e.g., the one or more first-party servers 191) references a system that is controlled by a party that is the same as the party that controls the automated assistant 120 referenced herein. For example, the one or more first-party servers 191 can reference a system that hosts a search engine service, a communications service (e.g., email, SMS messaging, etc.), a navigation service, a music service, a document editing or sharing service, and/or other services that are controlled a party that is the same as the party that controls the automated assistant 120 referenced herein. In contrast, a third-party device or system (e.g., the one or more third-party servers 192) references a system that is controlled by a party that is distinct from the party that controls the automated assistant 120 referenced herein. For example, the one or more third-party servers 192 can reference a system that hosts the same services, but those services are controlled by a party that is different from the party that controls the automated assistant 120 referenced herein.

The client device 110 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), an interactive standalone speaker (e.g., with or without a display), a smart networked device, such as a smart appliance, a smart television or smart washer/dryer, etc., a wearable apparatus of the user that includes a computing device (e.g., a watch of the user having a computing device, glasses of the user having a computing device, a virtual or augmented reality computing device), and/or any IoT device capable of receiving user input directed to the automated assistant 120. Additional and/or alternative client devices may be provided.

In various implementations, the client device 110 may include one or more presence sensors 111 that are configured to provide, with approval from corresponding user(s), signals indicative of detected presence, particularly human presence. In some of those implementations, the automated assistant 120 can identify the client device 110 (or another computing device associated with a user of the client device 110) to satisfy a spoken utterance (or other input directed to the automated assistant 120) based at least in part of presence of the user at the client device 110 (or at another computing device associated with the user of the client device 110). The spoken utterance (or other input directed to the automated assistant 120) can be satisfied by rendering responsive content (e.g., audibly and/or visually) at the client device 110 and/or other computing device(s) associated with the user of the client device 110, by causing the client device 110 and/or other computing device(s) associated with the user of the client device 110 to be controlled, and/or by causing the client device 110 and/or other computing device(s) associated with the user of the client device 110 to perform any other action to satisfy the spoken utterance (or other input directed to the automated assistant 120). As described herein, the automated assistant 120 can leverage data determined based on the presence sensors 111 in determining the client device 110 (or other computing device(s)) based on where a user is near or was recently near, and provide corresponding commands to only the client device 110 (or those other computing device(s)). In some additional or alternative implementations, the automated assistant 120 can leverage data determined based on the presence sensors 111 in determining whether any user(s) (any users or specific users) are currently proximal to the client device 110 (or other computing device(s)), and can optionally suppress provision of data to and/or from the client device 110 (or other computing device(s)) based on the user(s) that are proximal to the client device 110 (or other computing device(s)).

The presence sensors 111 may come in various forms. For example, the client device 110 may be equipped with one or more vision components (e.g., digital camera(s) and/or other vision component(s)) that are configured to capture and provide signal(s) indicative of movement detected in their fields of view. Additionally, or alternatively, the client device 110 may be equipped with other types of light-based presence sensors 111, such as passive infrared (“PIR”) sensors that measure infrared (“IR”) light radiating from objects within their fields of view. Additionally, or alternatively the client device 110 may be equipped with presence sensors 111 that detect acoustic (or pressure) waves, such as one or more microphones.

Additionally, or alternatively, in some implementations, the presence sensors 111 may be configured to detect other phenomena associated with human presence or device presence. For example, in some embodiments, the client device 110 may be equipped with a presence sensor 111 that detects various types of wireless signals (e.g., waves such as radio, ultrasonic, electromagnetic, etc.) emitted by, for instance, other computing devices carried/operated by a user (e.g., a mobile device, a wearable computing device, etc.) and/or other computing devices. For example, the client device 110 may be configured to emit waves that are imperceptible to humans, such as ultrasonic waves or infrared waves, that may be detected by other computing device(s) (e.g., via ultrasonic/infrared receivers such as ultrasonic-capable microphones).

Additionally, or alternatively, the client device 110 may emit other types of human-imperceptible waves, such as radio waves (e.g., Wi-Fi, Bluetooth, cellular, etc.) that may be detected by other computing device(s) carried/operated by a user (e.g., a mobile device, a wearable computing device, etc.) and used to determine the user's particular location. In some implementations, GPS and/or Wi-Fi triangulation may be used to detect a person's location, e.g., based on GPS and/or Wi-Fi signals to/from the client device 110. In other implementations, other wireless signal characteristics, such as time-of-flight, signal strength, etc., may be used by the client device 110, alone or collectively, to determine a particular person's location based on signals emitted by the other computing device(s) carried/operated by the user.

Additionally, or alternatively, in some implementations, the client device 110 may perform voice recognition to recognize a user from their voice. For example, some instances of the automated assistant 120 may be configured to match a voice to a user's profile, e.g., for purposes of providing/restricting access to various resources. In some implementations, movement of the speaker may then be determined, e.g., by the presence sensors 111 of the client device 110 (and optionally GPS sensors and/or accelerometers). In some implementations, based on such detected movement, a location of the user may be predicted, and this location may be assumed to be the user's location when any content is caused to be rendered at the client device 110 and/or other computing device(s) based at least in part on proximity of the client device 110 and/or other computing device(s) to the user's location. In some implementations, the user may simply be assumed to be in the last location at which he or she engaged with the automated assistant 120, especially if not much time has passed since the last engagement.

The client device 110 further include user interface component(s) 112, which can include one or more user interface input devices (e.g., microphone(s), touchscreen, keyboard, and/or other input devices) and/or one or more user interface output devices (e.g., display, speaker, projector, and/or other output devices). Further, the client device 110 and/or any other computing device(s) may include one or more memories for storage of data and software applications, one or more processors for accessing data and executing applications, and other components that facilitate communication over a network. The operations performed by the client device 110, other computing device(s), and/or by the automated assistant 120 may be distributed across multiple computer systems. The automated assistant 120 may be implemented as, for example, computer programs running on one or more computers in one or more locations that are coupled to each other through a network (e.g., the network(s) 199 of FIG. 1).

As noted above, in various implementations, the client device 110 may operate the automated assistant client 113. In various embodiments, the automated assistant client 113 may include a speech capture/automatic speech recognition (ASR)/natural language understanding (NLU)/text-to-speech (TTS) module 114. In other implementations, one or more aspects of the respective speech capture/ASR/NLU/TTS module 114 may be implemented separately from the automated assistant client 113 (e.g., by one or more of the cloud-based automated assistant components 115).

The speech capture/ASR/NLU/TTS module 114 may be configured to perform one or more functions including, for example: capture a user's speech (speech capture, e.g., via respective microphone(s) (which in some cases may comprise one or more of the presence sensors 111)); convert that captured audio to recognized text and/or to other representations or embeddings using ASR model(s) stored in the machine learning (ML) model(s) database 120A; parse and/or annotate the recognized text using NLU model(s) stored in the ML model(s) database 120A; and/or convert text-to-speech using TTS model(s) stored in the ML model(s) database 120A. Instance(s) of these ML model(s) may be stored locally at the client device 110 and/or accessible by the client device 110 over the network(s) 199 of FIG. 1. In some implementations, because the client device 110 may be relatively constrained in terms of computing resources (e.g., processor cycles, memory, battery, etc.), the respective speech capture/ASR/NLU/TTS module 114 that is local to the client device 110 may be configured to convert a finite number of different spoken phrases to text (or to other forms, such as lower dimensionality embeddings) using the speech recognition model(s). Some speech input may be sent to one or more of the cloud-based automated assistant components 115, which may include a cloud-based ASR module 116, a cloud-based NLU module 117, and/or a cloud-based TTS module 118. The cloud-based automated assistant components 115 can leverage the virtually limitless resources of the cloud to perform the same or similar functionality, but it should be noted that the speech capture/ASR/NLU/TTS module 114 can perform this functionality locally at the client device 110 without interacting with the cloud-based automated assistant components 115.

Although FIG. 1 is described with respect to a single client device having a single user, it should be understood that is for the sake of example and is not meant to be limiting. For example, one or more additional client devices of a user can also implement the techniques described herein. These additional client devices may be in communication with the client device 110 (e.g., over the network(s) 199). As another example, a given client device can be utilized by multiple users in a shared setting (e.g., a group of users, a household).

In some implementations, the client device 110 can further include various engines that are utilized in generating a plurality of disparate corresponding subsets of zero-prefix (ZP) suggestions for a plurality of disparate corresponding suggestion states that are associated with the client device 110, and subsequently utilizing the corresponding subsets of ZP suggestions to provide ZP suggestions for presentation to the user. For example, and as depicted in FIG. 1, the client device 110 can further include a device condition(s) engine 130, a suggestion state engine 140, a candidate ZP suggestion engine 150, a ZP suggestion engine 160, and a ZP tailoring engine 170. The client device 110 can further include on-device memory (or storage that may be transient or non-transient), including user profile(s) database 110A, ML model(s) database 120A, and ZP suggestions database 160A. In some implementations, these various engines can be executed exclusively on the client device 110. In additional or alternative implementations, one or more of these various engines can be executed remotely from the client device 110 (e.g., as part of the cloud-based automated assistant components 115).

As described herein, the client device 110 can utilize these various engines to generate, locally at the client device 110, the corresponding subsets of ZP suggestions for the corresponding suggestion states that are associated with the client device 110. Notably, some of these ZP suggestions can be tailored to the user of the client device 110. Further, the client device 110 can utilize these various engines to periodically update, locally at the client device 110, the corresponding subsets of ZP suggestions for the corresponding suggestion states that are associated with the client device 110. The corresponding subsets of ZP suggestions can be stored in association with the corresponding suggestion states in on-device memory (or storage) of the client device 110. Accordingly, when an occurrence of a given corresponding suggestion state is detected at the client device 110, a given corresponding subset of ZP suggestions that is specific to the given corresponding suggestion state and that includes one or more ZP suggestions that are tailored to the user of the client device 110 can quickly and efficiently be provided for presentation to the user of the client device 110.

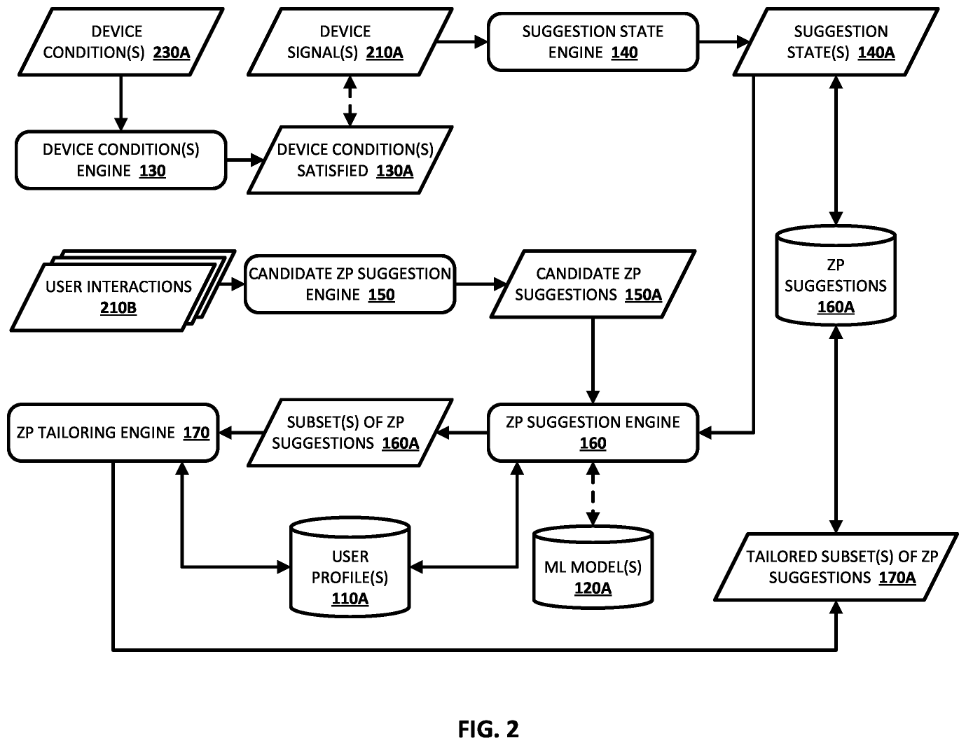

For example, and turning now to FIG. 2, an example process flows that demonstrate various aspects of the present disclosure is depicted. The process flow depicted in FIG. 2 can be performed by the automated assistant 120 utilizing the various engines of the client device 110 depicted in the example environment of FIG. 1. In some implementations, the automated assistant 120 may only generate the corresponding subsets of ZP suggestions for the corresponding suggestion states when one or more device conditions are satisfied. In these implementations, the device condition(s) engine 130 can continuously monitor one or more device conditions 230A to determine whether one or more of the device conditions are satisfied. The one or more device conditions 230A of the client device 110 of the user can include, for example, that the client device 110 is charging, that the client device 110 has at least a threshold state of charge, that a temperature of the client device 110 is less than a threshold, that the client device 110 is not being held by the user, that a new suggestion state associated with the client device 110 has been detected, a time of day at a location of the client device 110, and/or a day of week at the location of the client device 110. Put another way, the device condition(s) engine 130 can identify off-peak hours of usage of the client device 110 by the user and optionally limit generating of the corresponding subsets of ZP suggestions to those off-peak hours of usage of the client device 110 by the user to avoid interfering with usage of the client device 110 by the user. In these implementations, and assuming the device condition(s) engine 230A determines that the one or more device conditions 230A are satisfied, the device condition(s) engine 230A can send a signal to the suggestion state engine 140 that indicates the one or more device conditions 230A are satisfied as indicated by 130A.

The suggestion state engine 140 can identify a plurality of disparate corresponding suggestion states 140A that are associated with the client device 110. In some implementations, the suggestion state engine 140 can process one or more device signals 210A generated by the client device 110 to identify the plurality of disparate corresponding suggestion states 140A, and optionally assign each of the plurality of disparate corresponding suggestion states 140A a corresponding semantic identifier. The one or more device signals 210A can be identified during on-peak hours of usage of the client device 110 as they are detected (e.g., when the one or more device conditions 230A are not satisfied). In some implementations, the suggestion state engine 140 can process the one or more device signals 210A to identify the plurality of disparate corresponding suggestion states during these on-peak hours of usage of the client device 110. However, in additional or alternative implementations, the suggestion state engine 140 can store the one or more device signals 210A as they are detected, and subsequently process the one or more device signals 210A to identify the plurality of disparate corresponding suggestion states during the off-peak hours of usage of the client device 110 (e.g., when the one or more device conditions 230A are satisfied). These variations between on-peak hours and off-peak hours are indicated by the dashed arrow between the one or more device signals 210A and the one or more device signals being satisfied as indicated by 130A.

The one or more device signals 210A of the client device 110 of the user can include, for example, a location of the client device 110, a semantic indication of the location of the client device 110, a time or range of times associated with the location of the client device 110, a date associated with the location of the client device 110, a calendar entry associated with a calendar software application of the client device 110, an electronic communication associated with one or more electronic communication software applications of the client device 110, a given software application running in a foreground of the client device 110, a given software application running in a background of the client device 110, historical usage of one or more software applications accessible at the client device 110, an indication of one or more additional client devices in communication with the client device 110, or a clipboard that includes content copied at the client device 110. Each of the plurality of disparate corresponding suggestion states 140A can represent a different contextual scenario with varying degrees of granularity, and, as a result, the corresponding subset of ZP suggestions for each of the plurality of disparate corresponding suggestion states 140A can include one or more ZP suggestions that are relevant to each of the different contextual scenarios. Further, the suggestion state engine 140 can store each of the plurality of disparate corresponding suggestion states 140A in ZP suggestions database 160A as, for example, a table of ZP corresponding suggestion states.

For example, assume that the one or more device signals 210A indicate that a connection between the client device 110 and an in-vehicle computing device has been established (e.g., a Bluetooth connection) on a Friday morning at 9:00 AM. In this example, the suggestion state engine 140 can identify that the one or more device signals 210A correspond to a “commuting” suggestion state or a more specific “commuting to work” suggestion state or “commuting to work on a weekday morning”. As another example, assume that the one or more device signals 210A indicate that a connection between the client device 110 and a wireless headset has been established (e.g., a Bluetooth connection) on a Saturday morning at 9:00 AM, that a media application is running in a foreground of the client device 110, and that the client device 110 is located at a physical address associated with a gym. In this example, the suggestion state engine 140 can identify that the one or more device signals 210A correspond to a “media playback” suggestion state or a more specific “media playback for workout” suggestion state. As yet another example, assume that a calendar entry of a calendar application accessible at the client device 110 indicates that the user has an upcoming flight to a particular location, and that a note entry of a notes application accessible at the client device 110 information associated with the particular application. In this example, the suggestion state engine 140 can identify that the one or more device signals 210A correspond to a “travelling” suggestion state or a more specific “travelling to the particular location” suggestion state. Although the above example is provided with respect to identifying particular suggestion states, it should be understood that is for the sake of example and is not meant to be limiting. Rather, it should be understood that any combination of the one or more device signals 210A can be utilized to identify various other suggestion states.

The candidate ZP suggestion engine 150 can identify a superset of candidate ZP suggestions 150A (or a superset of raw candidate ZP suggestions) based on a plurality of user interactions 210B, of the user of the client device 110, with the client device 110 (e.g., private user interactions) and/or based on a plurality of user interactions 210B, of other users of respective client devices, with respective client devices (e.g., public user interactions). The ZP suggestions included in the superset of candidate ZP suggestions can be considered raw candidate ZP suggestions in that these ZP suggestions are determined based on a plurality of the plurality of user interactions 210B, but are not tailored to the user of the client device 110. In some implementations, the plurality of user interactions may be limited to instances when one or more of the device signals 210A are detected at the client device 110 and/or the respective client devices, respectively. The plurality of user interactions 210B can include, for example, user interactions with particular software applications accessible at the client device 110 and/or the respective client devices, such as launching a particular software application, accessing content that is available at a particular software application, etc.; user interactions with particular devices, such as controlling an additional device, including smart networked devices (e.g., smart lights, smart appliances, smart locks, a smart thermostat, a smart garage door, a smart television, etc.), in-vehicle devices or components (e.g., power windows, heating and air conditioning, a windshield defroster, vehicle locks, etc.), and/or other devices in communication with the client device 110 and/or the respective client devices; user interactions of copying and/or pasting particular content at the client device 110 and/or the respective client devices; and/or any other user interactions with the client device 110 and/or the respective client devices. For example, the user interactions can include utilizing a media application accessible at the client device 110 to play a particular song or podcast, utilizing a navigation application accessible at the client device 110 to obtain directions and/or traffic conditions, controlling heating and air conditioning of a vehicle of the user of the client device, calling or messaging a contact entry of a contacts application accessible at the client device 110 to communicate with an additional user, utilizing a smart lights application accessible at the client device 110 to control various smart lights associated with the smart lights application, scheduling a ride using a ridesharing application accessible at the client device 110, and/or any other user interaction. Put another way, user interactions detected at the client device 110 and/or the respective client devices during peak hours of usage can be subsequently utilized in generating the corresponding subsets of ZP suggestions during off-peak hours of usage of the client device 110. Although these user interactions may be performed in various contexts, each of these user interactions can be included in the superset of candidate ZP suggestions 150A. The superset of ZP suggestions can be stored in the ZP suggestions database 160A as, for example, a table of raw ZP suggestions.

The ZP suggestion engine 160 can process, using one or more ranking machine learning (ML) models stored in the ML model(s) database 120A (or one or more ranking ML rules stored in the ML model(s) database), each of the plurality of disparate corresponding suggestion states 140A and one or more of the ZP suggestions included in the superset of candidate ZP suggestions 150A to generate a corresponding score for each of the candidate ZP suggestions, included in the superset of candidate ZP suggestions 150A, and with respect to each of the plurality of disparate corresponding suggestion states 140A. The corresponding score for each of the candidate ZP suggestions, included in the superset of candidate ZP suggestions 150A, and with respect to each of the plurality of disparate corresponding suggestion states 140A can each indicate a likelihood that the user of the client device 110 will perform the user interaction associated with candidate ZP suggestion in view of the different contexts of the disparate suggestion states. For example, assume that the plurality of disparate corresponding suggestion states 140A include 10 disparate suggestion states, and that the superset of candidate ZP suggestions 150A include 100 disparate candidate ZP suggestions corresponding to the user interactions described above. In this example, the ZP suggestion engine 160 can generate, for a first suggestion state, of the 10 disparate suggestion states, 100 corresponding scores for each of the disparate candidate ZP suggestions; generate, for a second suggestion state, of the 10 disparate suggestion states, 100 additional corresponding scores for each of the disparate candidate ZP suggestions; and so on for the remaining suggestion states. Accordingly, in this example, the ZP suggestion engine 160 can generate 1,000 scores total (e.g., 100 scores for each of the 10 disparate suggestion states). Notably, the 10 disparate suggestion states can include suggestion states defined with varying degrees of granularity. For example, the 10 disparate suggestion states can include, for instance, the “commuting” suggestion state described above, the more specific “commuting to work” suggestion state described above, and the even more specific “commuting to work on a weekday morning”. As a result, the ZP suggestions that are provided for presentation to the user when an occurrence of one of these suggestion states is detected can reflect ZP suggestions that are most relevant to more specific and/or more general contextual scenarios.

In various implementations, the ZP suggestion engine 160 can select, based on the corresponding scores, and for each of the plurality of disparate corresponding suggestion states 140A, one or more ZP suggestions to include in corresponding subsets of ZP suggestions 160A for each of the plurality of disparate corresponding suggestion states 140A. In some versions of those implementations, the ZP suggestion engine 160 can select a threshold quantity of ZP suggestions for inclusion in each of the corresponding subsets of ZP suggestions 160A, and optionally discard any ZP suggestions, from the superset of candidate ZP suggestions 150A that are not selected for inclusion in any of the corresponding subsets of ZP suggestions 160A. Continuing with the above example, further assume the ZP suggestion engine 160 selects 10 ZP suggestions for inclusion in each of the corresponding subsets of ZP suggestions 160A. In this example, the ZP suggestion engine 160 can select the 10 ZP suggestions for each of the 10 disparate suggestion states, thereby resulting in 10 corresponding subsets of ZP suggestions that each include 10 ZP suggestions and that are each specific to a given one of the 10 disparate suggestion states. Notably, the ZP suggestions are not mutually exclusive in that a given ZP suggestion may be included in more than one of the corresponding subsets of ZP suggestions 160A.

In some implementations, the one or more ranking ML models utilized in processing each of the plurality of disparate corresponding suggestion states 140A and one or more of the ZP suggestions included in the superset of candidate ZP suggestions 150A to generate the corresponding scores can include a personal ranking ML model that is personalized to the user of the client device 110. In some versions of those implementations, the personal ranking ML model can be utilized to process one or more of the ZP suggestions included in the superset of candidate ZP suggestions 150A that are based on user interactions that are specific to the user of the client device 110. In additional or alternative implementations, the one or more ranking ML models utilized in processing each of the plurality of disparate corresponding suggestion states 140A and one or more of the ZP suggestions included in the superset of candidate ZP suggestions 150A to generate the corresponding scores can include a global ranking ML model that is not personalized to the user of the client device 110. In some versions of those implementations, the global ranking ML model can be utilized to process one or more of the ZP suggestions included in the superset of candidate ZP suggestions 150A that are based on user interactions that are specific to the user of the client device 110. In some versions of those implementations, the global ranking ML model can be utilized to process one or more of the ZP suggestions included in the superset of candidate ZP suggestions 150A that are based on user interactions that are not specific to the user of the client device 110, such as user interactions of the other users with the respective client devices.

In various implementations, in processing each of the plurality of disparate corresponding suggestion states 140A and one or more of the ZP suggestions included in the superset of candidate ZP suggestions 150A using the one or more ranking ML models, the ZP suggestion engine 140 can also process user profile data of the user of the client device 110. The user profile data of the user of the client device 110 can be obtained from the user profile(s) database 110A. The user profile data can include, for example, software application usage data (e.g., when the user of the client device 110 uses a particular software application, how the user of the client device 110 uses a particular software application, etc.), software application preference data (e.g., whether the user of the client device 110 prefers a particular software application for playing certain media content, obtaining navigation directions, booking ridesharing, etc.), smart home data (e.g., an indication of smart networked devices that are associated with a home graph of the user of the client device 110, a semantic identifier associated with each of the smart networked devices, etc.), browsing history, and/or any other data associated with the user of the client device 110 that is available locally at the client device 110.

In various implementations, one or more of the ZP suggestions that were selected for inclusion in the corresponding subsets of ZP suggestions 160A may need to be tailored to the user of the client device 110. For example, the automated assistant 120 can identify one or more ZP suggestions that were selected for inclusion in the corresponding subsets of ZP suggestions 160A, and that include a corresponding placeholder. For instance, assume a given ZP suggestion corresponds to “Call [CONTACT ENTRY]”, “Turn on [LIGHT LOCATION] lights”, or “Play podcast on [MEDIA APPLICATION]”. In this example, the corresponding placeholder for the given ZP suggestion can correspond to [CONTACT ENTRY], [LIGHT LOCATION], or [MEDIA APPLICATION], respectively. Further, in these implementations, the ZP tailoring engine can utilize the user profile data stored in the user profile(s) database 110A to populate the corresponding placeholders with corresponding personalized identifiers that are associated with the user of the client device 110.

In these implementations, the ZP tailoring engine 170 can identify the corresponding personalized identifiers that are associated with the user of the client device 110, and utilize the corresponding personalized identifiers to populate the corresponding placeholders associated with these ZP suggestions. For example, assume that “Call [CONTACT ENTRY]” is a given ZP suggestion that is selected for inclusion in a corresponding subset of ZP suggestions associated with a “commuting home from work” suggestion state, and assume that the user typically calls his/her spouse when commuting home from work. In this example, the ZP tailoring engine 170 can identify a contact entry associated with the user's spouse, resulting in the ZP suggestion of “Call spouse”. As another example, assume that “Call [CONTACT ENTRY]” is a given ZP suggestion that is selected for inclusion in a corresponding subset of ZP suggestions associated with a “commuting home from work” suggestion state, and assume that the user typically calls his/her sibling when commuting home from work. In this example, the ZP tailoring engine 170 can identify a contact entry associated with the user's sibling, resulting in the ZP suggestion of “Call sibling”. As another example, assume that “Play podcast on [MEDIA APPLICATION]” is a given ZP suggestion that is selected for inclusion in a corresponding subset of ZP suggestions associated with a “media playback” suggestion state, and assume that the user typically utilizes a first media application to listen to podcasts. In this example, the ZP tailoring engine 170 can identify a contact entry associated with the user's sibling, resulting in the ZP suggestion of “Play podcast on first media application”. Accordingly, the ZP tailoring engine 170 can tailor one or more ZP suggestions included in one or more of the corresponding subsets of ZP suggestions 160A, thereby resulting in one or more corresponding tailored subsets of ZP suggestions 170A. Further, the ZP tailoring engine 170 can cause the one or more corresponding tailored subsets of ZP suggestions 170A to be stored in association with a respective one of the plurality of disparate corresponding suggestion states 140A in the ZP suggestions database 160A.

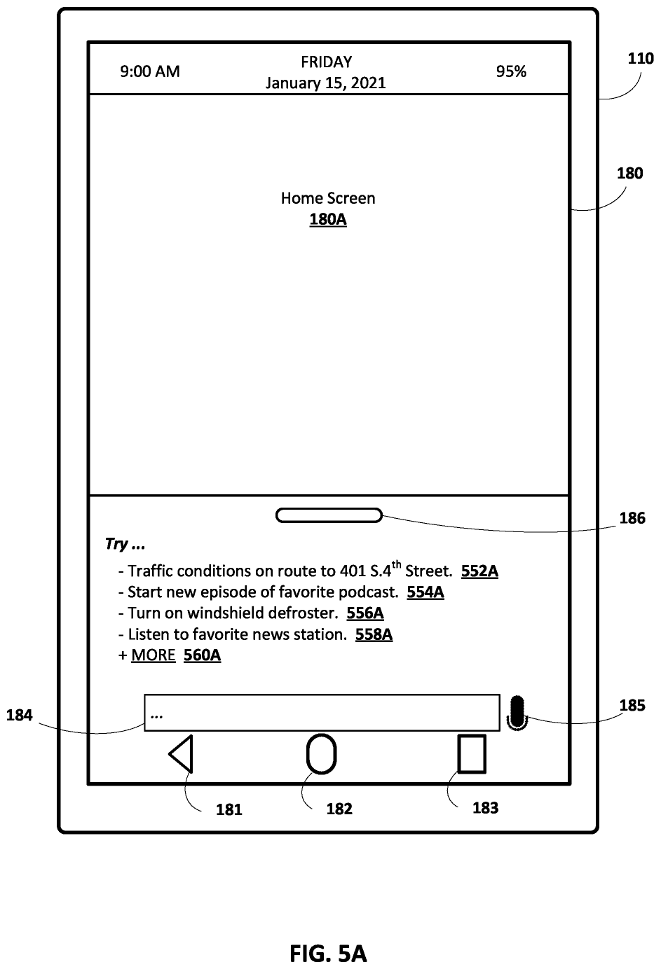

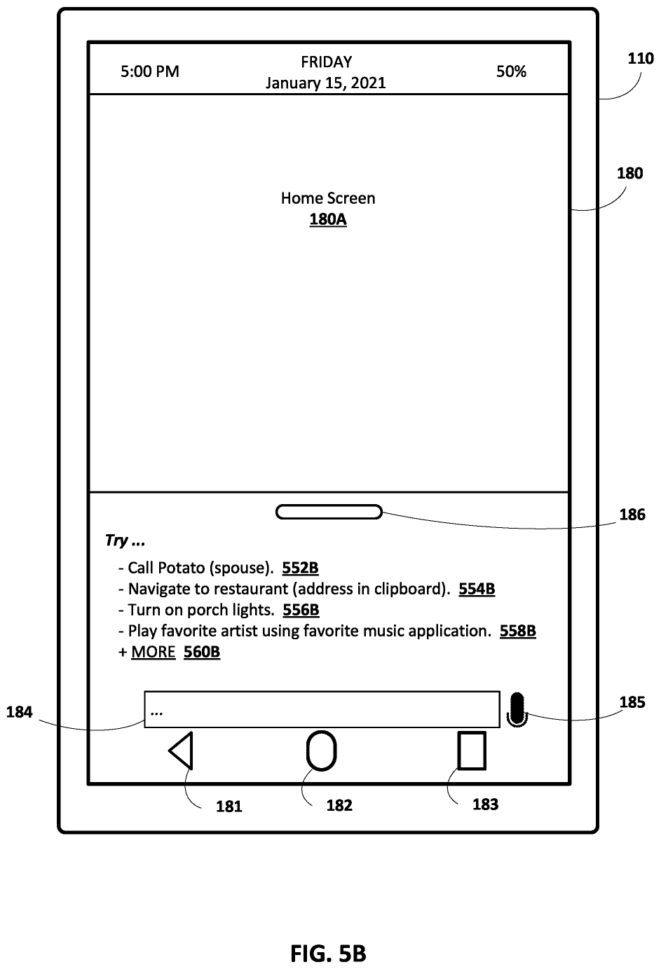

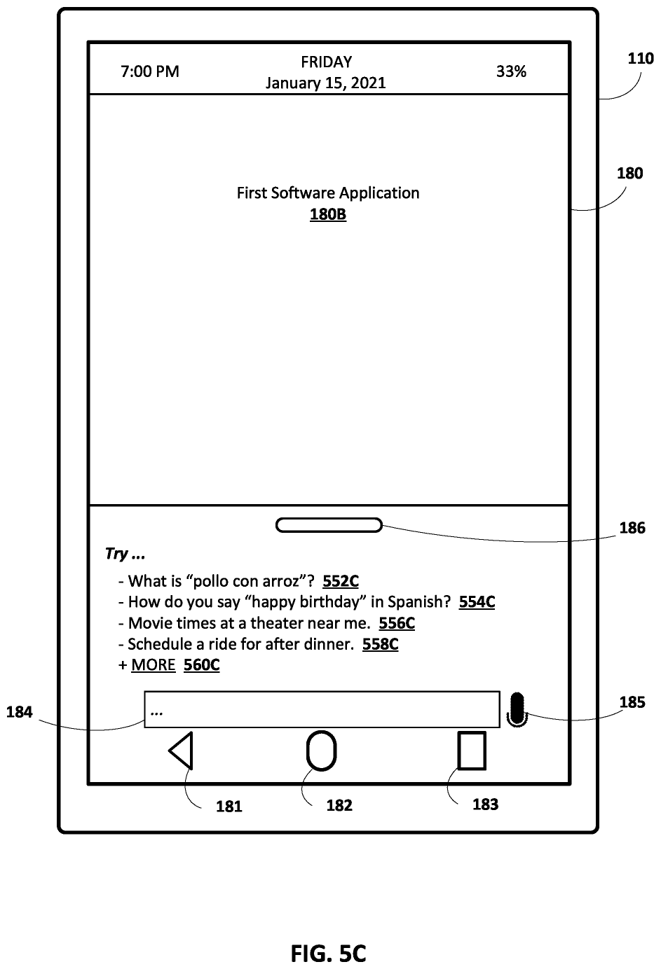

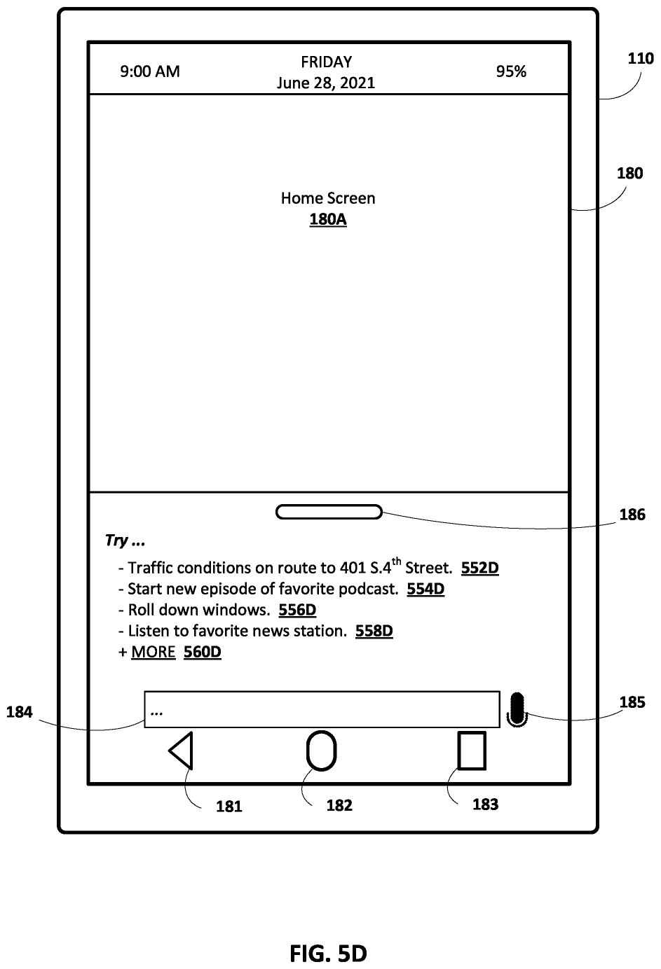

Accordingly, and as described in more detail with respect to FIGS. 5A-5D, when an occurrence of a given suggestion state is subsequently detected at the client device 110, the automated assistant 120 can quickly and efficiently obtain the corresponding subset of ZP suggestions that are stored in association with the given suggestion state. Further, the automated assistant 120 can cause one or more ZP suggestions from the corresponding subset of ZP suggestions to be provided for presentation to the user of the client device 110 without having to wait for various components of the client device 110 to be activated. In response to receiving a user selection of a given ZP suggestion that is provided for presentation to the user, the automated assistant 120 can initialize performance of one or more corresponding actions or assistant commands that are associated with the given ZP suggestion that was selected by the user of the client device 110. In various implementations, fulfillment data associated with each of the corresponding actions, for each of the ZP suggestions that are provided for presentation to the user, can be pre-cached in the on-device memory (or storage) of the client device 110 to further reduce latency in performance of the corresponding actions.

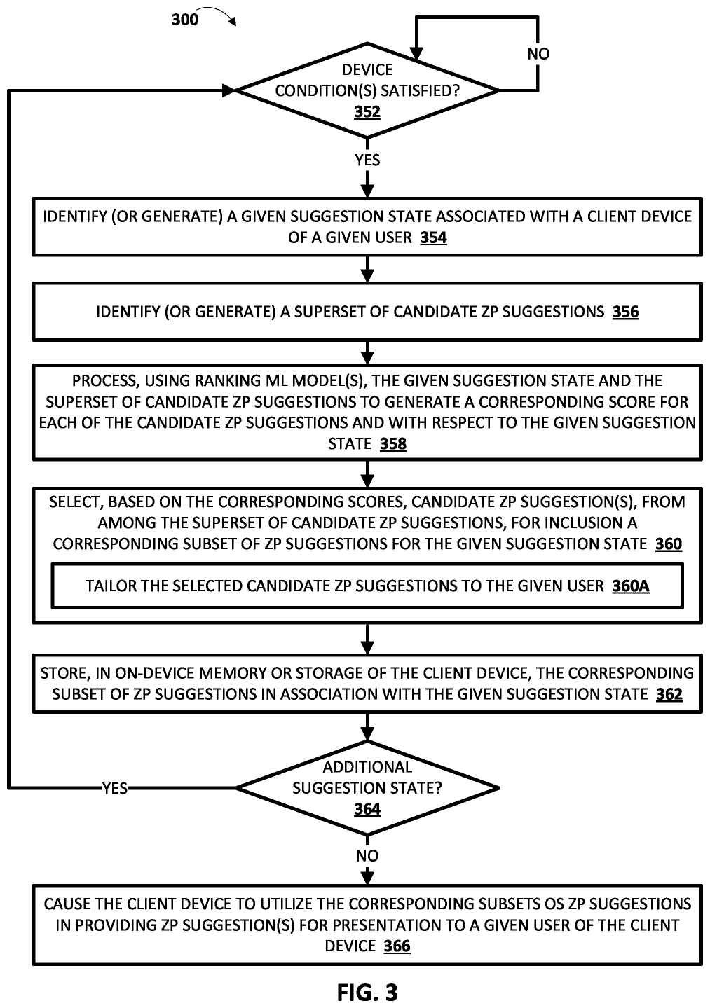

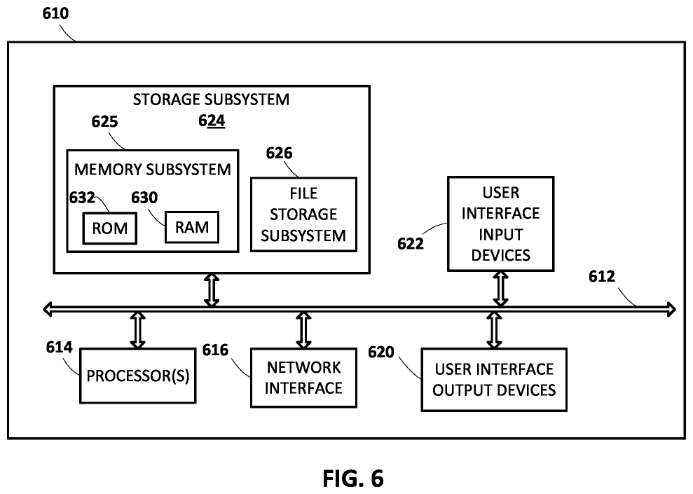

Turning now to FIG. 3, a flowchart illustrating an example method 300 of generating, locally at a client device, corresponding subset(s) of zero-prefix suggestions, for a user of the client device, and for suggestion state(s) associated with the client device, and subsequently causing the client device to utilize the corresponding subset(s) of zero-prefix suggestions is depicted. For convenience, the operations of the method 300 are described with reference to a system that performs the operations. This system of the method 300 includes one or more processors, memory, and/or other component(s) of computing device(s) (e.g., client device 110 of FIGS. 1 and 5A-5D, computing device 610 of FIG. 6, one or more servers, and/or other computing devices). Moreover, while operations of the method 300 are shown in a particular order, this is not meant to be limiting. One or more operations may be reordered, omitted, and/or added.

At block 352, the system determines whether one or more device conditions of a client device of a given user are satisfied. The one or more device conditions of the client device of the given user can include, for example, that the client device is charging, that the client device has at least a threshold state of charge, that a temperature of the client device is less than a threshold, that the client device is not being held by the given user, that a new suggestion state associated with the client device has been detected, a time of day at a location of the client device, a day of week at the location of the client device, and/or any other device conditions described herein. If, at an iteration of block 352, the system determines the one or more device conditions are not satisfied, the system continues monitoring for satisfaction of the one or more device conditions at block 352. If, at an iteration of block 352, the system determines the one or more device conditions are satisfied, the system proceeds to block 354.

At block 354, the system identifies (or generates) a given suggestion state associated with the client device of the given user. The given suggestion state may be one of a plurality of disparate suggestion states associated with the client device of the user. Each of the plurality of suggestion states can be associated with one or more device signals generated by the client device or an additional device in communication with the client device, and can be defined with varying degrees of granularity (e.g., as described with respect to the suggestion state engine 140 of FIGS. 1 and 2). The one or more device signals can include, for example, a location of the client device, a semantic indication of the location of the client device, a time or range of times associated with the location of the client device, a date associated with the location of the client device, a calendar entry associated with a calendar software application of the client device, an electronic communication associated with one or more electronic communication software applications of the client device, a given software application running in a foreground of the client device, a given software application running in a background of the client device, historical usage of one or more software applications accessible at the client device, an indication of one or more additional client devices in communication with the client device, or a clipboard that includes content copied at the client device. In some implementations, the given suggestion state can be generated during on-peak hours of usage of the client device as the one or more device signals are detected and when the one or more device conditions are not satisfied, and subsequently identified for generating a corresponding subset of ZP suggestions associated with the given suggestion state during off-peak hours of usage of the client device after the one or more device signals are detected and when the one or more device conditions are satisfied. In additional or alternative implementations, the given suggestion state can be generated during off-peak hours of usage of the client device after the one or more device signals are detected and when the one or more device conditions are satisfied.

Further, each of the plurality of suggestion states can be assigned a corresponding semantic identifier. For example, a hierarchy of disparate suggestion states defined with varying degrees of granularity may include a “Thai restaurant in the evening” suggestion state, a “Thai restaurant” suggestion state”, a “restaurant” suggestion state, and an “evening” suggestion state, where each of these suggestion states may be associated with one or more device signals. As another example, another hierarchy of disparate suggestion states defined with varying degrees of granularity may include a “media playback for morning workout” suggestion state, a “media playback for workout” suggestion state”, a “workout” suggestion state, and a “media playback” suggestion state, where each of these suggestion states may be associated with one or more device signals.

At block 356, the system identifies (or generates) a superset of candidate ZP suggestions (or superset of raw candidate ZP suggestions). The superset of candidate ZP suggestions can be identified (or generates) based on a plurality of user interactions of the given user with the client device (or other devices in communication with the client device) and/or a plurality of user interaction of other users with respective client devices (or other devices in communication with the respective client devices). The ZP suggestions included in the superset of candidate ZP suggestions can be considered raw candidate ZP suggestions in that these ZP suggestions are determined based on a plurality of the plurality of user interactions 210B, but are not tailored to the user of the client device 110. In some implementations, the plurality of user interactions considered may be limited to instances when one or more of the device signals associated with one or more suggestion states are detected at the client device of the user and/or the respective client devices of the other users, respectively. In some implementations, the superset of candidate ZP suggestions can be generated during on-peak hours of usage of the client device as the plurality of user interactions are detected and when the one or more device conditions are not satisfied, and subsequently identified for generating a corresponding subset of ZP suggestions associated with the given suggestion state during off-peak hours of usage of the client device after the plurality of user interactions are detected and when the one or more device conditions are satisfied. In additional or alternative implementations, the superset of candidate ZP suggestions can be generated during off-peak hours of usage of the client device after the one or more device signals are detected and when the one or more device conditions are satisfied. For example, assume the given user, upon entering a vehicle associated with the given user, utilizes an in-vehicle system to initiate and perform a phone call with a spouse, and, subsequent to performance of the phone call, utilize the in-vehicle system to cause media playback to be performed. In this example, an indication of the user interactions of initiating the phone call (and optionally with an indication that the phone call was between the user and the spouse) and causing media playback to be performed can be included in the superset of candidate ZP suggestions.

At block 358, the system processes, using one or more ranking ML models, the given suggestion state identified at block 354 and the superset of candidate ZP suggestions identified at block 356 to generate a corresponding score for each of the candidate ZP suggestions and with respect to the given suggestion state. For example, assume the superset of candidate ZP suggestions include 100 candidate ZP suggestions. In this example, a corresponding score for each of the candidate ZP suggestions can be generated based on processing the given suggestion state identified at block 354 and the superset of candidate ZP suggestions identified at block 356, thereby resulting in 100 corresponding scores. In some implementations, the system can process, using one or more of the ranking ML models, and along with the given suggestion state identified at block 354 and the superset of candidate ZP suggestions identified at block 356, user profile data of one or more user profiles of the given user of the client device. In some implementations, the one or more ranking ML models include a personal ranking ML model that is personal to the given user of the client device, whereas in other implementations, the one or more ranking ML models include a global ranking ML model that is not personal to the given user of the client device.

At block 360, the system selects, based on the corresponding scores, one or more candidate ZP suggestions, from among the superset of candidate ZP suggestions, for inclusion in a corresponding subset of ZP suggestions and with respect to the given suggestion state. In some implementations, the system can select a threshold quantity of the candidate ZP suggestions for inclusion in the corresponding subset of ZP suggestions based on the corresponding scores. For example, the system can select five, seven, eight, or any other quantity of candidate ZP suggestions, from among the superset of candidate ZP suggestions, based on the corresponding scores associated with those candidate ZP suggestions indicating that they are more relevant to the given user of the client device in view of the given suggestion state. In some implementations, at block 360A, the system tailors the selected candidate ZP suggestions to the user. The system can identify any of the candidate ZP suggestions selected for inclusion in the corresponding subset of ZP suggestions that are associated with a corresponding placeholder, such as a corresponding placeholder for an entity reference placeholder associated with a particular contact entry, a software application identifier placeholder associated with a preferred software application for a particular assistant command, a smart networked device identifier placeholder associated with one or more particular smart networked devices. Further, the system can determine one or more personalized identifiers to be utilized in populating the corresponding placeholders based on user profile data of one or more user profiles of the given user of the client device (e.g., stored in the user profile(s) database 110A of FIG. 1).

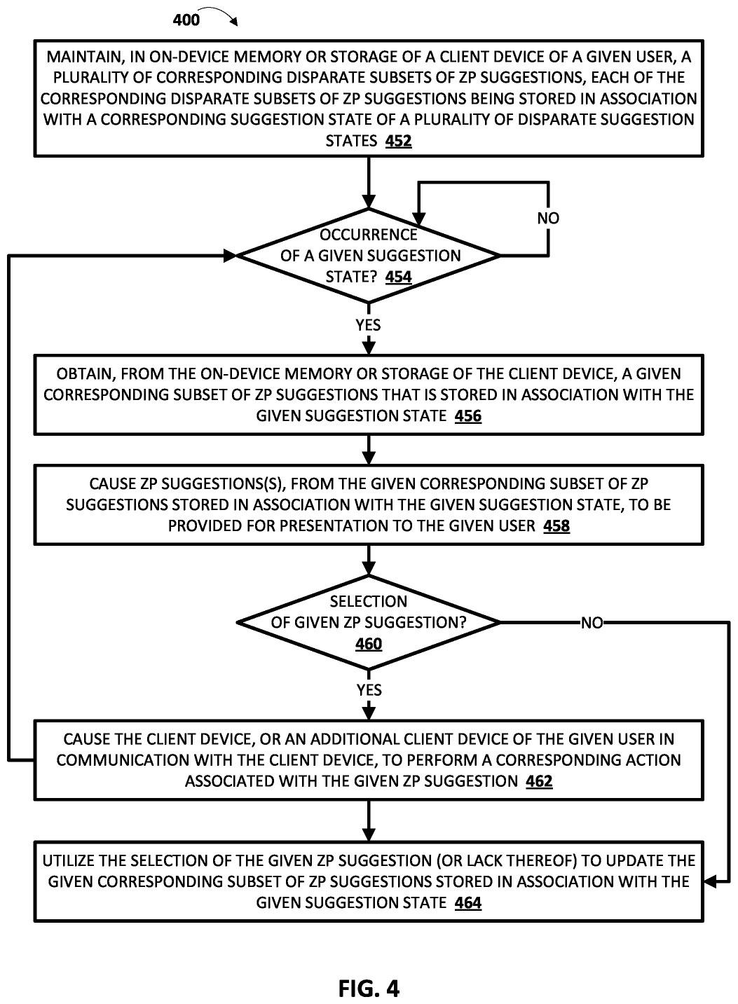

At block 362, the system stores, in on-device memory of the client device, the corresponding subset of ZP suggestions in association with the given suggestion state. At block 364, the system determines whether there is an additional suggestion state associated with the client device to generate an additional corresponding subset of ZP suggestions for the additional suggestion state. If, at an iteration of block 364, the system determines there is an additional given suggestion state associated with the client device to generate an additional corresponding subset of ZP suggestions for the additional given suggestion state, the system returns to block 352 to perform an additional iteration of the method 300, but with respect to the additional given suggestion state rather than the given suggestion state. For example, in generating the additional corresponding subset of ZP suggestions, the system can process the same superset of candidate ZP suggestions, but different device signal(s) that are associated with the additional suggestion state and include at least one unique device signal that is not associated with the suggestion state. If, at an iteration of block 364, the system determines there is no additional given suggestion state associated with the client device to generate an additional corresponding subset of ZP suggestions for the additional given suggestion state, the system proceeds to block 366 At block 366, the system causes the client device to utilize the corresponding subsets of ZP suggestions in providing one or more ZP suggestions for presentation to a given user of the client device (e.g., as described with respect to the method 400 of FIG. 4).

Although only a single instance of block 352 is depicted in the method 300 of FIG. 3 and the single instance of block 352 is depicted at the beginning of the method 300 of FIG. 3, it should be understood that is for the sake of example and is not meant to be limiting. In some implementations, one or more additional instances of block 352 may be implemented throughout performance of the method 300 of FIG. 3. For example, an additional instance of block 352 may be implemented between each of the blocks of the method 300 of FIG. 3. In some versions of those implementations, and in response to determining that one or more of the device conditions are no longer satisfied, an iteration of the method 300 of FIG. 3 may be paused, and data characterizing a state of the iteration of the method 300 of FIG. 3 can be saved in on-device memory (or storage) of the client device such that, when the one or more device conditions are subsequently satisfied, the data characterizing a state of the iteration of the method 300 of FIG. 3 can be loaded and the iteration of the method 300 of FIG. 3 can be resumed.

Further, although the method 300 of FIG. 3 is described with respect to initially generating the corresponding subsets of ZP suggestions for a plurality of disparate suggestion states, it should be understood that is for the sake of example and is not meant to be limiting. For example, subsequent iterations of the method 300 can be implemented to subsequently update the corresponding subsets of ZP suggestions for the plurality of disparate suggestion states. In some implementations, subsequent iterations of the method 300 can be implemented to subsequently update the corresponding subsets of ZP suggestions for the plurality of disparate suggestion states each time the one or more device conditions are satisfied. In additional or alternative implementations, subsequent iterations of the method 300 can be implemented to subsequently update the corresponding subsets of ZP suggestions for the plurality of disparate suggestion states when the one or more device conditions are satisfied after a threshold duration of time has lapsed (e.g., when the one or more device conditions are satisfied a week after initially generating the corresponding subsets of ZP suggestions or updating the corresponding subsets of ZP suggestions). In additional or alternative implementations, subsequent iterations of the method 300 can be implemented to subsequently update the corresponding subsets of ZP suggestions for the plurality of disparate suggestion states when the one or more device conditions are satisfied after determining a new suggestion state is detected (e.g., based on detecting a new, unique combination of device signals at the client device) or determining a new suggestion state is anticipated (e.g., based on calendar data of a calendar application accessible at the client device indicating an upcoming event (e.g., upcoming flight, upcoming dinner, etc.), based on electronic communications of one or more electronic communication applications (e.g., a text messaging application, an email application, a social media application, etc.) accessible at the client device indicating an upcoming event, etc.).

Turning now to FIG. 4, a flowchart illustrating an example method 400 of utilizing corresponding subset(s) of zero-prefix suggestions that were previously generated locally at a client device based on detecting occurrence(s) of suggestion state(s) is depicted. For convenience, the operations of the method 400 are described with reference to a system that performs the operations. This system of the method 400 includes one or more processors, memory, and/or other component(s) of computing device(s) (e.g., client device 110 of FIGS. 1 and 5A-5D, computing device 610 of FIG. 6, one or more servers, and/or other computing devices). Moreover, while operations of the method 400 are shown in a particular order, this is not meant to be limiting. One or more operations may be reordered, omitted, and/or added.

At block 452, the system maintains, in on-device memory (or storage) of a client device of a given user, a plurality of corresponding disparate subsets of ZP suggestions, each of the corresponding disparate subsets of ZP suggestions being stored in association with a corresponding suggestion state of a plurality of disparate suggestion states. The system can maintain the plurality of corresponding disparate subsets of ZP suggestions and the corresponding disparate subsets of ZP suggestions in the on-device memory (or storage) of the client device of the given user using one or more iterations of the method 300 of FIG. 3.

At block 454, the system determines whether an occurrence of a given suggestion state has been detected. The system can determine whether an occurrence of a given suggestion state has been detected when one or more device signals associated with the given suggestion state are detected at the client device of the given user or an additional device in communication with the client device of the given user. The one or more device signals are described herein (e.g., with respect to the suggestion state engine 140 of FIGS. 1 and 2, and with respect to block 354 of FIG. 3). If, at an iteration of block 454, the system determines an occurrence of a given suggestion state has not been detected, the system continues monitoring for an occurrence of a given suggestion state at block 454. If, at an iteration of block 454, the system determines an occurrence of a given suggestion state has been detected, the system proceeds to block 456.

At block 456, the system obtains, from the on-device memory (or storage) of the client device, a given corresponding subset of ZP suggestions that is stored in association with the given suggestion state. For example, a plurality of disparate corresponding subsets of ZP suggestions can be stored in association with a plurality of disparate corresponding suggestion states in the on-device memory (or storage) of the client device of the given user. The system can identify, in the on-device memory (or storage) of the client device of the given user, the given suggestion state that was detected at the client device, and can retrieve the corresponding subset of ZP suggestions that is stored in association with the given suggestion state in the on-device memory (or storage).

At block 458, the system causes one or more ZP suggestions, from the given corresponding subset of ZP suggestions stored in association with the given suggestion state, to be provided for presentation to the given user. In some implementations, a quantity of ZP suggestions that are provided for presentation to the given user may be based on a size of a display area, of the client device or an additional client device in communication with the client device, for the ZP suggestions. For example, the corresponding subset of ZP suggestions stored in association with the given suggestion state may include 10 ZP suggestions. However, the size of the display area for the ZP suggestions may only include space available for a portion of the ZP suggestions included in the corresponding subset of ZP suggestions, such as three ZP suggestions. In this example, the system may select three ZP suggestions from the 10 ZP suggestions to be provided for presentation to the user (e.g., based on the corresponding scores associated with the 10 ZP suggestions generated at block 358 of FIG. 3), and the system may optionally provide a selectable element that, when selected, causes one or more other ZP suggestions from the 10 ZP suggestions to be provided for presentation to the user. In other implementations, each of the ZP suggestions from the corresponding subset of ZP suggestions may be provided for presentation to the user.

At block 460, the system determines whether a user selection of a given ZP suggestion is received from the given user of the client device. The user selection can be, for example, a voice selection of the given ZP suggestion detected via microphone(s) of the client device or an additional client device in communication with the client device and/or a touch selection of the ZP suggestion detected via a display of the client device or an additional client device in communication with the client device. If, at an iteration of block 460, the system determines that no selection of any ZP suggestion is received from the given user of the client device, the system proceeds to block 464. Block 464 is described in more detail below. If, at an iteration of block 460, the system determines that a selection of a given ZP suggestion is received from the given user of the client device, the system proceeds to block 462.

At block 462, the system causes the client device, or an additional client device of the given user in communication with the client device, to perform a corresponding action associated with the given ZP suggestion. The corresponding action associated with the given ZP suggestion can vary based on the given ZP suggestion (e.g., as described with respect to FIGS. 5A-5D). At block 464, the system utilizes the selection of the given ZP suggestion (or lack thereof) to update the given corresponding subset of ZP suggestions stored in association with the given suggestion state. For example, the selection of the given ZP suggestion (or lack thereof) can be utilized to influence which ZP suggestions, from among the corresponding subset of ZP suggestions, should be provided for presentation to the given user in response to detecting a future occurrence of the given suggestion state. Put another way, the selection of the given ZP suggestion (or lack thereof) can be utilized to modify the corresponding score associated with the given ZP suggestion and optionally modify the corresponding scores associated with the other ZP suggestions that are provided for presentation to the given user. For instance, and assuming the given ZP suggestion is selected by the given user, the system can modify the corresponding score associated with the given ZP suggestion to make it more likely the given ZP suggestion will be provided for presentation to the given user in response to detecting a future occurrence of the given suggestion state. Also, for instance, and assuming none of the ZP suggestions are selected by the given user, the system can modify the corresponding scores associated with those ZP suggestions to make it less likely those ZP suggestions will be provided for presentation to the given user in response to detecting a future occurrence of the given suggestion state. As another example, the selection of the given ZP suggestion (or lack thereof) can be utilized to influence which ZP suggestions, from among the corresponding subset of ZP suggestions, should be included in the corresponding subset of ZP suggestions stored in association with the given suggestion state. Put another way, the selection of the given ZP suggestion (or lack thereof) can be utilized in subsequently updating the corresponding set of ZP suggestions stored in association with the given suggestion state. For instance, and assuming none of the ZP suggestions are selected by the given user, the system can modify the corresponding scores associated with those ZP suggestions to make it less likely those ZP suggestions will be included in the corresponding subset of ZP suggestion stored in association with the given suggestion state when the corresponding subset of ZP suggestions is subsequently updated.

Turning now to FIGS. 5A-5D, various non-limiting examples of utilizing corresponding subset(s) of zero-prefix suggestions that were previously generated locally at a client device 110 based on detecting occurrence(s) of suggestion state(s) are depicted. The client device 110 may include various user interface components including, for example, microphone(s) to generate audio data based on spoken utterances and/or other audible input, speaker(s) to audibly render synthesized speech and/or other audible output, and/or a display 180 to visually render ZP suggestions and/or other visual output. Further, the display 180 of the client device 110 can include various system interface elements 181, 182, and 183 (e.g., hardware and/or software interface elements) that may be interacted with by the user of the client device 110 to cause the client device 110 to perform one or more actions. The display 180 of the client device 110 enables the user to interact with content rendered on the display 180 by touch input (e.g., by directing user input to the display 180 or portions thereof (e.g., to text entry box 184, to keyboard 186, or to other portions of the display 180)) and/or by spoken input (e.g., by selecting microphone interface element 185—or just by speaking without necessarily selecting the microphone interface element 185 (i.e., the automated assistant may monitor for one or more terms or phrases, gesture(s) gaze(s), mouth movement(s), lip movement(s), and/or other conditions to activate spoken input) at the client device 110). Although the client device 110 depicted in FIGS. 5A-5D is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing the automated assistant to engage in a human-to-computer dialog session with a user.

Referring specifically to FIG. 5A, assume a user of the client device 110 has entered his/her vehicle to commute to work, and that a display 180 the client device 110 is displaying a user interface associated with a home screen 180A of the client device 110. Further assume a corresponding subset of ZP suggestions associated with a “weekday morning commute to work” suggestion state was previously generated and stored in on-device memory (or storage) of the client device 110 in association with the “weekday morning commute to work” suggestion state (e.g., using techniques described with respect to FIGS. 2 and 3). In the example of FIG. 5A, the client device 110 can detect an occurrence of the “weekday commute to work” suggestion state based on various device signal(s) matching those initially identified for the “weekday morning commute to work” suggestion state in generating the corresponding subset of ZP suggestions. For example, an occurrence of the “weekday morning commute to work” suggestion state can be detected based on, for example, a time of day (e.g., 9:00 AM) associated with a location of the client device 110, a day of week (e.g., Friday) associated with the location of the client device 110, a date (e.g., Jan. 15, 2021) associated with the location of the client device 110, an indication of one or more additional client devices in communication with the client device (e.g., a Bluetooth connection between the client device 110 and an in-vehicle computing device), and/or based on other device signal(s) described herein that were previously identified as corresponding to the “weekday morning commute to work” suggestion state. As described herein, the plurality of disparate suggestion states can be defined with varying degrees of granularity. Accordingly, it should be understood that the “weekday morning commute to work” suggestion state is provided for the sake of example and is not meant to be limiting. For example, one or more other suggestion states that are more specific and/or more general can additionally or alternatively be identified, and corresponding subsets of ZP suggestions for those other suggestion states can also be generated. For instance, other corresponding subsets of ZP suggestions associated with a “weekday morning commute” suggestion state, a “weekday morning” suggestion state, and/or other suggestion states can additionally or alternatively be generated and stored in association in the on-device memory (or storage) of the client device 110.

Further assume the corresponding subset of ZP suggestions stored in association with the “weekday morning commute to work” suggestion state include, for example: a first ZP suggestion 552A of “Traffic conditions on route to 401 S. 4th St.” where “401 S. 4th St.” corresponds to a work address as a personalized identifier of the user of the client device 110 for populating a corresponding placeholder, and that, when selected, causes traffic conditions along one or more routes to the work address to be provided for audibly and/or visually provided for presentation to the user via the client device 110 or the in-vehicle computing device of the vehicle; a second ZP suggestion 554A of “Start new episode of favorite podcast” that, when selected, causes a new episode of the user's favorite podcast to be played back for audible presentation to the user via the client device 110 and/or via the in-vehicle computing device of the vehicle (and optionally using a preferred media application of the user); a third ZP suggestion 556A of “Turn on windshield defroster” that, when selected, causes a windshield defroster of the vehicle to be activated via the in-vehicle computing device that is in communication with the client device 110; and a fourth ZP suggestion 558A of “Listen to favorite news station” that, when selected, causes the user's favorite news station to be played back for audible presentation to the user via the client device 110 and/or via the in-vehicle computing device of the vehicle (and optionally using a preferred media application of the user or a radio of the vehicle). In some implementations, the corresponding subset of ZP suggestions can include additional ZP suggestions that are stored in association with the “weekday morning commute to work” suggestion state, but are not provided for presentation to the user due at least in part to a display area of the display 180. In these implementations, the client device 110 may further display a selectable element 560A that, when selected, causes one or more additional ZP suggestions to be provided for presentation to the user by either expanding the list of ZP suggestions or supplanting the ZP suggestions that are displayed with one or more of the additional ZP suggestions. Additionally, or alternatively, the user of the client device 110 can dismiss the ZP suggestions that are provided for presentation to the user by swiping down on element 186.

In the example of FIG. 5A, each of the ZP suggestions that are provided for presentation can be included in the corresponding subset of ZP suggestions associated with the “weekday morning commute to work” suggestion state based on prior user interactions of the user of the client device 110 and/or other users. For example, assume that the user has historically viewed traffic conditions using a navigation application prior to commuting to work to determine a quickest route to the work address. In this example, the corresponding score generated for the first ZP suggestion 552A, and with respect to the “weekday morning commute to work” suggestion state, should indicate that the first ZP suggestion 552A should be selected for inclusion in the corresponding subset of ZP suggestions. As another example, assume that the user has typically listened to a favorite podcast or favorite news station while commuting to work (and optionally using a preferred media application). In this example, the corresponding scores generated for the second ZP suggestion 554A and the fourth ZP suggestion 558A, and with respect to the “weekday morning commute to work” suggestion state, should indicate that the second ZP suggestion 554A and the fourth ZP suggestion 558A should be selected for inclusion in the corresponding subset of ZP suggestions. As yet another example, assume that the user has generally caused a windshield defroster to be activated over the last several months while the weather has been cold at a location of the client device 110. In this example, the corresponding score generated for the third ZP suggestion 556A, and with respect to the “weekday morning commute to work” suggestion state, should indicate that the third ZP suggestion 556A should be selected for inclusion in the corresponding subset of ZP suggestions.

Referring specifically to FIG. 5B, assume a user of the client device 110 has entered his/her vehicle to commute home from work, and that a display 180 the client device 110 is displaying the user interface associated with the home screen 180A of the client device 110. Further assume a corresponding subset of ZP suggestions associated with a “weekday evening commute home from work” suggestion state was previously generated and stored in on-device memory (or storage) of the client device 110 in association with the “weekday evening commute home from work” suggestion state (e.g., using techniques described with respect to FIGS. 2 and 3). In the example of FIG. 5B, the client device 110 can detect an occurrence of the “weekday evening commute home from work” suggestion state based on various device signal(s) matching those initially identified for the “weekday evening commute home from work” suggestion state in generating the corresponding subset of ZP suggestions. For example, an occurrence of the “weekday evening commute home from work” suggestion state can be detected based on, for example, a time of day (e.g., 5:00 PM) associated with a location of the client device 110, a day of week (e.g., Friday) associated with the location of the client device 110, a date (e.g., Jan. 15, 2021) associated with the location of the client device 110, an indication of one or more additional client devices in communication with the client device (e.g., a Bluetooth connection between the client device 110 and an in-vehicle computing device), and/or based on other device signal(s) described herein that were previously identified as corresponding to the “weekday evening commute home from work” suggestion state.

Further assume the corresponding subset of ZP suggestions stored in association with the “weekday evening commute home from work” suggestion state include, for example: a first ZP suggestion 552B of “Call potato” where “potato” corresponds to a contact entry associated with the user's spouse (e.g., a personalized identifier) that is accessible at a contacts application of the client device 110 and that, when selected, causes the client device 110 to initiate a telephone call with the user's spouse via the client device 110; a second ZP suggestion 554B of “Navigate to restaurant” that, when selected, causes a navigation application that is accessible at the client device 110 to obtain navigation directions to an address associated with a restaurant that is copied to a clipboard of the client device 110; a third ZP suggestion 556B of “Turn on porch lights” that, when selected, causes one or more lights assigned a semantic identifier “porch lights” to be illuminated via a smart light application that is accessible at the client device 110; and a fourth ZP suggestion 558B of “Play favorite artist using favorite music application” that, when selected, causes a song from the user's favorite artists to be played back for audible presentation to the user via the client device 110 and/or via the in-vehicle computing device of the vehicle and using a preferred media application of the user. In some implementations, and similar to FIG. 5A, the corresponding subset of ZP suggestions can include additional ZP suggestions that are stored in association with the “weekday evening commute home from work” suggestion state, but are not provided for presentation to the user due at least in part to a display area of the display 180. In these implementations, the client device 110 may further display a selectable element 560B that, when selected, causes one or more additional ZP suggestions to be provided for presentation to the user by either expanding the list of ZP suggestions or supplanting the ZP suggestions that are displayed with one or more of the additional ZP suggestions. Additionally, or alternatively, the user of the client device 110 can dismiss the ZP suggestions that are provided for presentation to the user by swiping down on element 186.

In the example of FIG. 5B, each of the ZP suggestions that are provided for presentation can be included in the corresponding subset of ZP suggestions associated with the “weekday evening commute home from work” suggestion state based on prior user interactions of the user of the client device 110 and/or other users. For example, assume that the user has historically called a spouse when leaving work. In this example, the corresponding score generated for the first ZP suggestion 552B, and with respect to the “weekday evening commute home from work” suggestion state, should indicate that the first ZP suggestion 552B should be selected for inclusion in the corresponding subset of ZP suggestions. As another example, assume that the user typically turns on the “porch lights” in winter months when leaving work to ensure the user has sufficient light when arriving at home in darker months. In this example, the corresponding score generated for the third ZP suggestion 556B, and with respect to the “weekday evening commute home from work” suggestion state, should indicate that the third ZP suggestion 556B should be selected for inclusion in the corresponding subset of ZP suggestions. As yet another example, assume that the user has generally listened to music of a favorite artist when driving home from work to help decompress. In this example, the corresponding score generated for the fourth ZP suggestion 558B, and with respect to the “weekday evening commute home from work” suggestion state, should indicate that the fourth ZP suggestion 558B should be selected for inclusion in the corresponding subset of ZP suggestions.

In various implementations, and with respect to the second ZP suggestion 554B, one or more ZP suggestions can be based on transient information at the client device 110 (e.g., information copied to a clipboard of the client device 110 or otherwise transiently stored at the client device 110). In these implementations, the corresponding placeholders associated with these ZP suggestions may not be populated with corresponding personalized identifiers until the transient information is available at the client device (e.g., rather than in initially generating the corresponding subset of ZP suggestions as with the first ZP suggestion 552A of “Call potato”). Moreover, in these implementations, any suggestions that include transient information can be promoted above other ZP suggestions such that these ZP suggestions are provided for presentation to the user, rather than having to be discovered by the user of the client device 110 via one or more selections of the selectable element 560B. Although FIGS. 5A and 5B are described with respect to occurrences of suggestion states being detected at least in part on detecting a connection between the client device 110 and an additional computing device (e.g., the in-vehicle computing device of the vehicle of the user), it should be understood that is for the sake of example and is not meant to be limiting.

For example, and referring specifically to FIG. 5C, assume a user of the client device 110 has arrived at a location associated with Example Mexican Restaurant (i.e., a fictitious Mexican restaurant), and that a display 180 the client device 110 is displaying a user interface associated with a first software application 180B. Further assume a corresponding subset of ZP suggestions associated with a “dinner at Example Mexican Restaurant” suggestion state was previously generated and stored in on-device memory (or storage) of the client device 110 in association with the “dinner at Example Mexican Restaurant” suggestion state (e.g., using techniques described with respect to FIGS. 2 and 3). In the example of FIG. 5B, the client device 110 can detect an occurrence of the “dinner at Example Mexican Restaurant” suggestion state based on various device signal(s) matching those initially identified for the “dinner at Example Mexican Restaurant” suggestion state in generating the corresponding subset of ZP suggestions. In this example, the “dinner at Example Mexican Restaurant” suggestion state may be identified based on, for example, a calendar entry of a calendar application that is accessible at the client device 110 indicating that the user has reservations on Friday night, launching of the first software application 180B (e.g., a browser application, a translation application, etc.). Accordingly, an occurrence of the “dinner at Example Mexican Restaurant” suggestion state can be detected based on, for example, a time of day (e.g., 7:00 PM) associated with a location of the client device 110 matching the reservation time, a day of week (e.g., Friday) associated with the location of the client device 110 matching the reservation week day, a date (e.g., Jan. 15, 2021) associated with the location of the client device 110 matching the reservation date, a location of the client device 110 matching a known location of Example Mexican Restaurant, and/or based on other device signal(s) described herein that were previously identified as corresponding to the “dinner at Example Mexican Restaurant” suggestion state.

Further assume the corresponding subset of ZP suggestions stored in association with the “dinner at Example Mexican Restaurant” suggestion state include, for example: a first ZP suggestion 552c of “What is ‘pollo con arroz’?” that, when selected, causes the client device 110 to translate “polio con arroz” from Spanish to English or causes the client device 110 to execute a query for “polio con arroz”; a second ZP suggestion 554C of “How do you say ‘happy birthday’ in Spanish?” that, when selected, causes the client device 110 to translate “happy birthday” from English to Spanish or causes the client device 110 to execute a query for “‘happy birthday’ in Spanish” at the client device 110; a third ZP suggestion 556C of “Movie times at a theater near me” that, when selected, causes the client device 110 to obtain movie times for one or more movies at a theater that is near a location of the client device 110; and a fourth ZP suggestion 558C of “Schedule a ride for after dinner” that, when selected, causes the client device 110. In some implementations, and similar to FIGS. 5A and 5B, the corresponding subset of ZP suggestions can include additional ZP suggestions that are stored in association with the “dinner at Example Mexican Restaurant” suggestion state, but are not provided for presentation to the user due at least in part to a display area of the display 180. In these implementations, the client device 110 may further display a selectable element 560C that, when selected, causes one or more additional ZP suggestions to be provided for presentation to the user by either expanding the list of ZP suggestions or supplanting the ZP suggestions that are displayed with one or more of the additional ZP suggestions. Additionally, or alternatively, the user of the client device 110 can dismiss the ZP suggestions that are provided for presentation to the user by swiping down on element 186.

In the example of FIG. 5C, each of the ZP suggestions that are provided for presentation can be included in the corresponding subset of ZP suggestions associated with the “dinner at Example Mexican Restaurant” suggestion state based on prior user interactions of the user of the client device 110 and/or other users. For example, assume that the user and/or other users historically ask for translations of particular words and/or phrases when eating at a Mexican restaurant. In this example, the corresponding scores generated for the first ZP suggestion 552C and the second ZP suggestion 554C, and with respect to the “dinner at Example Mexican Restaurant” suggestion state, should indicate that the first ZP suggestion 552C and the second ZP suggestion 554C should be selected for inclusion in the corresponding subset of ZP suggestions. As another example, assume that the user typically goes out to see a movie after eating dinner. In this example, the corresponding score generated for the third ZP suggestion 556C, and with respect to the “dinner at Example Mexican Restaurant” suggestion state, should indicate that the third ZP suggestion 556C should be selected for inclusion in the corresponding subset of ZP suggestions. As yet another example, assume that the user has generally booked a ride using a ridesharing application to get home from dinner, or to a movie after dinner. In this example, the corresponding score generated for the fourth ZP suggestion 558C, and with respect to the “dinner at Example Mexican Restaurant” suggestion state, should indicate that the fourth ZP suggestion 558C should be selected for inclusion in the corresponding subset of ZP suggestions.

As described herein, the corresponding subsets of ZP suggestions can be updated when one or more device conditions are satisfied after a threshold duration of time has lapsed (e.g., once a day, once a week, once every month, etc.). For example, and referring specifically to FIG. 5D, assume the user of the client device 110 has entered his/her vehicle to commute to work, and that the display 180 the client device 110 is displaying a user interface associated with the home screen 180A of the client device 110 as described with respect to FIG. 5A. Further assume a corresponding subset of ZP suggestions associated with a “weekday morning commute to work” suggestion state was previously generated and stored in on-device memory (or storage) of the client device 110 in association with the “weekday morning commute to work” suggestion state (e.g., using techniques described with respect to FIGS. 2 and 3). In the example of FIG. 5D, the client device 110 can similarly detect an occurrence of the “weekday commute to work” suggestion state based on various device signal(s) matching those initially identified for the “weekday morning commute to work” suggestion state in generating the corresponding subset of ZP suggestions. However, in the example of FIG. 5D, a date (e.g., Jun. 28, 2021) associated with the location of the client device 110 may differ from the date associated with the client device 110 in the example of FIG. 5A (e.g., Jan. 15, 2021).

Accordingly, in the example of FIG. 5D, one or more ZP suggestions included in the corresponding subset of ZP suggestions stored in association with the “weekday morning commute to work” suggestion state may differ from those of FIG. 5A. For example, the corresponding subset of ZP suggestions may include a third ZP suggestion 556D of “Roll down windows” that, when selected, causes windows of the vehicle to be rolled down via the in-vehicle computing device that is in communication with the client device 110, rather than causing a windshield defroster to be activated as described above with respect to FIG. 5A. In the example of FIG. 5D, the third ZP suggestion 556C can be included in the corresponding subset of ZP suggestions associated with the “weekday morning commute to work” suggestion state based on prior user interactions of the user of the client device 110 and/or other users. For example, assume that the user has generally caused windows to be rolled down over the last several months while the weather has been warm at a location of the client device 110. In this example, the corresponding score generated for the third ZP suggestion 556D, and with respect to the “weekday morning commute to work” suggestion state, should indicate that the third ZP suggestion 556D should be selected for inclusion in the corresponding subset of ZP suggestions.

Notably, one or more of the other ZP suggestions that are stored in association with the “weekday morning commute to work” suggestion state and that are provided for presentation to the user, such as a first ZP suggestion 552D of “Traffic conditions on route to 401 S. 4^{th} St.”, a second ZP suggestion 554D of “Start new episode of favorite podcast”, and a fourth ZP suggestion 558D of “Listen to favorite news station”, may be the same as those provided for presentation to the user of the client device 110 in FIG. 5A. Further, in some implementations, the client device 110 may further display a selectable element 560D that, when selected, causes one or more additional ZP suggestions to be provided for presentation to the user by either expanding the list of ZP suggestions or supplanting the ZP suggestions that are displayed with one or more of the additional ZP suggestions. However, in the example of FIG. 5D, one or more of the ZP suggestions provided for presentation to the user (e.g., the third ZP suggestion 556D) may differ from those provided for presentation to the user in the example of FIG. 5A at least based on how the user interactions with the client device 110 or additional computing devices in communication with the client device 110 change over time. Accordingly, the ZP suggestions that are provided for presentation to the user can be updated over time to ensure the ZP suggestions are tailored to the user as contextual scenarios that are encountered at the client device 110 change over time.

Although particular suggestion states and particular ZP suggestions are described with respect to FIGS. 5A-5D, it should be understood that those suggestions states and ZP suggestions are provided for the sake of example and are not meant to be limiting. For example, it should be understood that the suggestions states described herein are a function of virtually limitless contextual scenarios that can vary from user to user. As another example, it should be understood that those ZP suggestions that are generated for those suggestion states are a function of different user interactions that can also vary from user to user. Further, although a particular quantity and arrangement of the particular ZP suggestions are described with respect to FIGS. 5A-5D, it should be understood that is for the sake of example and is not meant to be limiting. For example, more or less ZP suggestions that the quantity depicted throughout FIGS. 5A-5D can be provided for presentation to the user. Also, for example, the ZP suggestions can be provided for presentation to the user as a pop-up notification, a banner notification, in a separate ZP suggestions user interface that can supplant a user interface being displayed at the client device 110, and/or in any other manner for presenting visual content at the client device 110.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes generating, locally at a client device, a corresponding subset of zero-prefix suggestions for a given user of the client device and for a given suggestion state associated with the client device. Each of the zero-prefix suggestions included in the corresponding subset of zero-prefix suggestions is tailored to the given user. Generating the corresponding subset of zero-prefix suggestions for the given user and for the given suggestion state includes identifying the given suggestion state associated with the client device; identifying a superset of candidate zero-prefix suggestions; processing, using one or more ranking machine learning (ML) models, the given suggestion state and the superset of candidate zero-prefix suggestions to generate a corresponding score for each of the candidate zero-prefix suggestions and with respect to the given suggestion state; and selecting, based on the corresponding scores, one or more of the candidate zero-prefix suggestions, from among the superset of candidate zero-prefix suggestions, for inclusion in the corresponding subset of zero-prefix suggestions. The method further includes storing, in on-device memory or storage of the client device, the corresponding subset of zero-prefix suggestions in association with the given suggestion state; and subsequent to storing the corresponding subset of zero-prefix suggestions in association with the given suggestion state, causing the client device to utilize the corresponding subset of zero-prefix suggestions in providing one or more zero-prefix suggestions for presentation to the given user.

These and other implementations of technology disclosed herein can optionally include one or more of the following features.

In some implementations, the method may further include determining whether one or more client device conditions are satisfied at a first time. Generating the corresponding subset of zero-prefix suggestions for the given user and for the given suggestion state may be in response to determining the one or more client device conditions are satisfied at the first time. In some versions of those implementations, the one or more client device conditions may include one or more of: that the client device is charging, that the client device has at least a threshold state of charge, that a temperature of the client device is less than a threshold, that the client device is not being held by the given user, that the given suggestion state is a new suggestion state associated with the client device has been detected, a time of day at a location of the client device, or a day of week at the location of the client device. In additional or alternative versions of those implementations, the method may further include determining whether one or more client device conditions are satisfied at a second time that is subsequent to the first time; and in response to determining the one or more client device conditions are satisfied at the second time: updating the corresponding subset of zero-prefix suggestions for the given user and for the given suggestion state to generate an updated corresponding subset of zero-prefix suggestions for the given user and for the given suggestion state. In some further versions of those implementations, the method may further include replacing, in the on-device memory or storage, the corresponding subset stored in association with the given suggestion state with the updated corresponding subset of zero-prefix suggestions.

In some implementations, the method may further include generating, locally at the client device, an additional corresponding subset of zero-prefix suggestions for the given user and for an additional given suggestion state associated with the client device. Each of the zero-prefix suggestions included in the additional corresponding subset of zero-prefix suggestions may be tailored to the given user, and the additional suggestion state may differ from the given suggestion state. Further, at least one zero-prefix suggestion included in the additional corresponding subset of zero-prefix suggestions for the additional suggestion state may differ from the zero-prefix suggestions included in the corresponding subset of zero-prefix suggestions for the given suggestion state. Moreover, generating the additional corresponding subset of zero-prefix suggestions for the given user for the additional suggestion state may include identifying the additional suggestion state associated with the client device; identifying the superset of candidate zero-prefix suggestions; processing, using one or more ranking machine learning (ML) models, the additional suggestion state and the superset of candidate zero-prefix suggestions to generate an additional corresponding score for each of the candidate zero-prefix suggestions and with respect to the additional suggestion state; and selecting, based on the additional corresponding scores, one or more of the candidate zero-prefix suggestions, from among the superset of candidate zero-prefix suggestions, for inclusion in the additional corresponding subset of zero-prefix suggestions. The method may further include storing, in on-device memory or storage of the client device, the additional corresponding subset of zero-prefix suggestions in association with the additional suggestion state; and subsequent to storing the additional corresponding subset of zero-prefix suggestions in association with the additional suggestion state, causing the client device to utilize the additional corresponding subset of zero-prefix suggestions in providing one or more of the zero-prefix suggestions for presentation to the given user.

In some implementations, generating the corresponding subset of zero-prefix suggestions for the given user and for the given suggestion state may further include causing one or more of zero-prefix suggestions selected for inclusion in the corresponding subset of zero-prefix suggestions to be tailored to the given user. Causing one or more of zero-prefix suggestions selected for inclusion in the corresponding subset of zero-prefix suggestions to be tailored to the given user may include identifying one or more of zero-prefix suggestions selected for inclusion in the corresponding subset that are associated with a corresponding placeholder; and populating the corresponding placeholder associated with one or more of zero-prefix suggestions selected for inclusion in the corresponding subset with a corresponding personalized identifier that is associated with the given user. In some versions of those implementations, the corresponding personalized identifier that is associated with the given user may include one or more of: a contact entry identifier associated with a contact entry of the given user, a media identifier associated with media of interest to the given user, a home automation device identifier of a home automation device associated with the given user, a software application identifier of a software application accessible by the client device of the given user. In additional or alternative versions of those implementations, populating the corresponding placeholder with the corresponding personalized identifier that is associated with the given user may include accessing a user profile of the given user stored locally in the on-device memory or storage to identify the corresponding personalized identifiers associated with the given user; and selecting the corresponding personalized identifiers utilized to populate the corresponding placeholder based on a type of the corresponding placeholder and based on the user profile.

In some implementations, identifying the given suggestion state may include identifying one or more corresponding signals associated with the given suggestion state; and storing, in the on-device memory or storage, the one or more corresponding signals in association with the given suggestion state. In some versions of those implementations, the one or more corresponding signals associated with the given suggestion state may include one or more of: a location of the client device, a semantic indication of the location of the client device, a time or range of times associated with the location of the client device, a date associated with the location of the client device, a calendar entry associated with a calendar software application of the client device, an electronic communication associated with one or more electronic communication software applications of the client device, a given software application running in a foreground of the client device, a given software application running in a background of the client device, historical usage of one or more software applications accessible at the client device, an indication of one or more additional client devices in communication with the client device, or a clipboard that includes content copied at the client device. In additional or alternative versions of those implementations, identifying the superset of candidate zero-prefix suggestions may include identifying a plurality of user interactions, of the given user, with the client device or an additional client device of the given user that are performed when one or more of the corresponding signals are detected by the client device; or identifying a plurality of user interactions, of one or more additional users, with a respective client device or a respective additional client device that are performed when one or more of the corresponding signals are detected by the respective client device.

In some implementations, selecting one or more of the candidate zero-prefix suggestions for inclusion in the corresponding subset of zero-prefix suggestions may include identifying, based on the corresponding scores for the candidate zero-prefix suggestions and with respect to the given suggestion state, a threshold quantity of zero-prefix suggestions to be included in the corresponding subset of zero-prefix suggestions for the given suggestion state. In some versions of those implementations, the method may further include discarding any zero-prefix suggestions, from the superset of zero-prefix suggestions, that are not selected for inclusion in the corresponding subset of zero-prefix suggestions for the given suggestion state.

In some implementations, the one or more ranking ML models may include at least a global ranking ML model that is not personalized to the given user of the client device. In additional or alternative implementations, the one or more ranking ML models may include at least a personal ranking ML model that is personalized to the given user of the client device.

In some implementations, causing the client device to utilize the corresponding subset of zero-prefix suggestions in providing one or more zero-prefix suggestions for presentation to the given user may include detecting an occurrence of the given suggestion state associated with the client device; and in response to detecting the occurrence the given suggestion state: obtaining, from the on-device memory or storage, the corresponding subset of zero-prefix suggestions associated stored in association with the given suggestion state; and causing one or more of the zero-prefix suggestions, from the corresponding subset of zero-prefix suggestions stored in association with the given suggestion state, to be provided for presentation to the user. In some versions of those implementations, causing one or more of the zero-prefix suggestions to be provided for presentation to the user may include causing one or more of the zero-prefix suggestions to be visually rendered for presentation to the user via a display of the client device.

In some implementations, a method implemented by one or more processors is provided, and includes maintaining, in on-device memory or storage of a client device of a given user, a plurality of corresponding disparate subsets of zero-prefix suggestions, each of the corresponding disparate subsets of zero-prefix suggestions being stored in association with a corresponding suggestion state of a plurality of disparate suggestion states; detecting an occurrence of a given suggestion state associated with the client device, the given suggestion state being one of the plurality of disparate suggestion states; and in response to detecting the occurrence of the given suggestion state associated with the client device: obtaining, from the on-device memory or storage, a given corresponding subset of zero-prefix suggestions, of the plurality of corresponding disparate subsets of zero-prefix suggestions, that is stored in association with the given suggestion state; causing one or more zero-prefix suggestions, from the given corresponding subset of the zero-prefix suggestions stored in association with the given suggestion state, to be provided for presentation to the given user; and in response to receiving a selection of a given zero-prefix suggestion from among the one or more zero-prefix suggestions provided for presentation to the given user: causing the client device, or an additional client device of the given user in communication with the client device, to perform a corresponding action associated with the given zero-prefix suggestion.

These and other implementations of technology disclosed herein can optionally include one or more of the following features.

In some implementations, each of the one or more zero-prefix suggestions provided for presentation to the given user may be associated with corresponding actions that, when selected, cause the client device or the additional client device to perform the corresponding action associated with a corresponding one of the one or more zero-prefix suggestions. In some versions of those implementations, fulfillment data associated with each of the corresponding actions may be pre-cached in the on-device memory or storage of the client device.

In some implementations, in response to receiving a selection of a given zero-prefix suggestion from among the one or more zero-prefix suggestions provided for presentation to the given user, the method may further include utilizing the selection of the given zero-prefix suggestion as a feedback signal to update a ranking of the one or more zero-prefix suggestions.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
generating, locally at a client device, a corresponding subset of zero-prefix suggestions for a given user of the client device and for a given suggestion state associated with the client device, wherein each of the zero-prefix suggestions included in the corresponding subset of zero-prefix suggestions is tailored to the given user, and wherein generating the corresponding subset of zero-prefix suggestions for the given user and for the given suggestion state comprises:
identifying the given suggestion state associated with the client device;
identifying a superset of candidate zero-prefix suggestions;
processing, using one or more ranking machine learning (ML) models, the given suggestion state and the superset of candidate zero-prefix suggestions to generate a corresponding score for each of the candidate zero-prefix suggestions and with respect to the given suggestion state; and
selecting, based on the corresponding scores, one or more of the candidate zero-prefix suggestions, from among the superset of candidate zero-prefix suggestions, for inclusion in the corresponding subset of zero-prefix suggestions;
storing, in on-device memory or storage of the client device, the corresponding subset of zero-prefix suggestions in association with the given suggestion state; and
subsequent to storing the corresponding subset of zero-prefix suggestions in association with the given suggestion state, causing the client device to utilize the corresponding subset of zero-prefix suggestions in providing one or more zero-prefix suggestions for presentation to the given user.

2. The method of claim 1, further comprising:
determining whether one or more client device conditions are satisfied at a first time;
wherein generating the corresponding subset of zero-prefix suggestions for the given user and for the given suggestion state is in response to determining the one or more client device conditions are satisfied at the first time.

3. The method of claim 2, wherein the one or more client device conditions include one or more of: that the client device is charging, that the client device has at least a threshold state of charge, that a temperature of the client device is less than a threshold, that the client device is not being held by the given user, that the given suggestion state is a new suggestion state associated with the client device has been detected, a time of day at a location of the client device, or a day of week at the location of the client device.

4. The method of claim 2, further comprising:
determining whether one or more client device conditions are satisfied at a second time that is subsequent to the first time; and
in response to determining the one or more client device conditions are satisfied at the second time:
updating the corresponding subset of zero-prefix suggestions for the given user and for the given suggestion state to generate an updated corresponding subset of zero-prefix suggestions for the given user and for the given suggestion state.

5. The method of claim 4, further comprising:
replacing, in the on-device memory or storage, the corresponding subset stored in association with the given suggestion state with the updated corresponding subset of zero-prefix suggestions.

6. The method of claim 1, further comprising:
generating, locally at the client device, an additional corresponding subset of zero-prefix suggestions for the given user and for an additional given suggestion state associated with the client device, wherein each of the zero-prefix suggestions included in the additional corresponding subset of zero-prefix suggestions is tailored to the given user, wherein the additional suggestion state differs from the given suggestion state, wherein at least one zero-prefix suggestion included in the additional corresponding subset of zero-prefix suggestions for the additional suggestion state differs from the zero-prefix suggestions included in the corresponding subset of zero-prefix suggestions for the given suggestion state, and wherein generating the additional corresponding subset of zero-prefix suggestions for the given user for the additional suggestion state comprises:
identifying the additional suggestion state associated with the client device;
identifying the superset of candidate zero-prefix suggestions;
processing, using one or more ranking machine learning (ML) models, the additional suggestion state and the superset of candidate zero-prefix suggestions to generate an additional corresponding score for each of the candidate zero-prefix suggestions and with respect to the additional suggestion state; and
selecting, based on the additional corresponding scores, one or more of the candidate zero-prefix suggestions, from among the superset of candidate zero-prefix suggestions, for inclusion in the additional corresponding subset of zero-prefix suggestions;
storing, in on-device memory or storage of the client device, the additional corresponding subset of zero-prefix suggestions in association with the additional suggestion state; and
subsequent to storing the additional corresponding subset of zero-prefix suggestions in association with the additional suggestion state, causing the client device to utilize the additional corresponding subset of zero-prefix suggestions in providing one or more of the zero-prefix suggestions for presentation to the given user.

7. The method of claim 1, wherein generating the corresponding subset of zero-prefix suggestions for the given user and for the given suggestion state further comprises:
causing one or more of zero-prefix suggestions selected for inclusion in the corresponding subset of zero-prefix suggestions to be tailored to the given user, wherein causing one or more of zero-prefix suggestions selected for inclusion in the corresponding subset of zero-prefix suggestions to be tailored to the given user comprises:
identifying one or more of zero-prefix suggestions selected for inclusion in the corresponding subset that are associated with a corresponding placeholder; and
populating the corresponding placeholder associated with one or more of zero-prefix suggestions selected for inclusion in the corresponding subset with a corresponding personalized identifier that is associated with the given user.

8. The method of claim 7, wherein the corresponding personalized identifier that is associated with the given user includes one or more of: a contact entry identifier associated with a contact entry of the given user, a media identifier associated with media of interest to the given user, a home automation device identifier of a home automation device associated with the given user, a software application identifier of a software application accessible by the client device of the given user

9. The method of claim 7, wherein populating the corresponding placeholder with the corresponding personalized identifier that is associated with the given user comprises:
accessing a user profile of the given user stored locally in the on-device memory or storage to identify the corresponding personalized identifiers associated with the given user; and
selecting the corresponding personalized identifiers utilized to populate the corresponding placeholder based on a type of the corresponding placeholder and based on the user profile.

10. The method of claim 1, wherein identifying the given suggestion state comprises:
identifying one or more corresponding signals associated with the given suggestion state; and
storing, in the on-device memory or storage, the one or more corresponding signals in association with the given suggestion state.

11. The method of claim 10, wherein the one or more corresponding signals associated with the given suggestion state comprises one or more of: a location of the client device, a semantic indication of the location of the client device, a time or range of times associated with the location of the client device, a date associated with the location of the client device, a calendar entry associated with a calendar software application of the client device, an electronic communication associated with one or more electronic communication software applications of the client device, a given software application running in a foreground of the client device, a given software application running in a background of the client device, historical usage of one or more software applications accessible at the client device, an indication of one or more additional client devices in communication with the client device, or a clipboard that includes content copied at the client device.

12. The method of claim 10, wherein identifying the superset of candidate zero-prefix suggestions comprises:
identifying a plurality of user interactions, of the given user, with the client device or an additional client device of the given user that are performed when one or more of the corresponding signals are detected by the client device; or
identifying a plurality of user interactions, of one or more additional users, with a respective client device or a respective additional client device that are performed when one or more of the corresponding signals are detected by the respective client device.

13. The method of claim 1, wherein selecting one or more of the candidate zero-prefix suggestions for inclusion in the corresponding subset of zero-prefix suggestions comprises:
identifying, based on the corresponding scores for the candidate zero-prefix suggestions and with respect to the given suggestion state, a threshold quantity of zero-prefix suggestions to be included in the corresponding subset of zero-prefix suggestions for the given suggestion state.

14. The method of claim 13, further comprising:
discarding any zero-prefix suggestions, from the superset of zero-prefix suggestions, that are not selected for inclusion in the corresponding subset of zero-prefix suggestions for the given suggestion state.

15. The method of claim 1, wherein causing the client device to utilize the corresponding subset of zero-prefix suggestions in providing one or more zero-prefix suggestions for presentation to the given user comprises:
detecting an occurrence of the given suggestion state associated with the client device; and
in response to detecting the occurrence the given suggestion state:
obtaining, from the on-device memory or storage, the corresponding subset of zero-prefix suggestions associated stored in association with the given suggestion state; and
causing one or more of the zero-prefix suggestions, from the corresponding subset of zero-prefix suggestions stored in association with the given suggestion state, to be provided for presentation to the user.

16. A method implemented by one or more processors, the method comprising:
maintaining, in on-device memory or storage of a client device of a given user, a plurality of corresponding disparate subsets of zero-prefix suggestions, each of the corresponding disparate subsets of zero-prefix suggestions being stored in association with a corresponding suggestion state of a plurality of disparate suggestion states;
detecting an occurrence of a given suggestion state associated with the client device, the given suggestion state being one of the plurality of disparate suggestion states; and
in response to detecting the occurrence of the given suggestion state associated with the client device:
obtaining, from the on-device memory or storage, a given corresponding subset of zero-prefix suggestions, of the plurality of corresponding disparate subsets of zero-prefix suggestions, that is stored in association with the given suggestion state;
causing one or more zero-prefix suggestions, from the given corresponding subset of the zero-prefix suggestions stored in association with the given suggestion state, to be provided for presentation to the given user; and
in response to receiving a selection of a given zero-prefix suggestion from among the one or more zero-prefix suggestions provided for presentation to the given user:
causing the client device, or an additional client device of the given user in communication with the client device, to perform a corresponding action associated with the given zero-prefix suggestion.

17. The method of claim 16, wherein each of the one or more zero-prefix suggestions provided for presentation to the given user are associated with corresponding actions that, when selected, cause the client device or the additional client device to perform the corresponding action associated with a corresponding one of the one or more zero-prefix suggestions.

18. The method of claim 17, wherein fulfillment data associated with each of the corresponding actions is pre-cached in the on-device memory or storage of the client device.

19. The method of claim 16, in response to receiving a selection of a given zero-prefix suggestion from among the one or more zero-prefix suggestions provided for presentation to the given user, further comprising:
utilizing the selection of the given zero-prefix suggestion as a feedback signal to update a ranking of the one or more zero-prefix suggestions.

20. A client device comprising:
one or more processors; and
on-device memory or storage storing instructions that, when executed, cause one or more of the processors to:
generate, locally at the client device, a corresponding subset of zero-prefix suggestions for a given user of the client device and for a given suggestion state associated with the client device, wherein each of the zero-prefix suggestions included in the corresponding subset of zero-prefix suggestions is tailored to the given user, and wherein the instructions to generate the corresponding subset of zero-prefix suggestions for the given user and for the given suggestion state comprise instructions to:
identify the given suggestion state associated with the client device;
identify a superset of candidate zero-prefix suggestions;
process, using one or more ranking machine learning (ML) models, the given suggestion state and the superset of candidate zero-prefix suggestions to generate a corresponding score for each of the candidate zero-prefix suggestions and with respect to the given suggestion state; and
select, based on the corresponding scores, one or more of the candidate zero-prefix suggestions, from among the superset of candidate zero-prefix suggestions, for inclusion in the corresponding subset of zero-prefix suggestions;
store, in the on-device memory of the client device, the corresponding subset of zero-prefix suggestions in association with the given suggestion state; and
subsequent to storing the corresponding subset of zero-prefix suggestions in association with the given suggestion state, cause the client device to utilize the corresponding subset of zero-prefix suggestions in providing one or more zero-prefix suggestions for presentation to the given user.
